(19) United States
(12) Patent Application Publication
(10) Pub. No.: US 2006/0092642 A1
(43) Pub. Date: May 4, 2006

(54) Light emitting module, optical head, and optical disc recording and reproducing apparatus

(76) Inventors: Hideki Nakata, Kyoto (JP); Hironori Tomita, Nara (JP); Hideki Aikoh, Osaka (JP); Takayuki Nagata, Osaka (JP)

Correspondence Address: RATNERPRESTIA, P.O. BOX 980, VALLEY FORGE, PA, 19482, US

(21) Appl. No.: 11/261,293

(22) Filed: Oct. 28, 2005

(30) Foreign Application Priority Data
Oct. 29, 2004 (JP) 2004-315447

(51) Int. Cl. F21V 29/00

(52) U.S. Cl. 362/294; 369/112.23

(57) ABSTRACT

A light emitting module used for an optical head having a light source and a single or plural light receiving elements and for using record or reproduce information on information recording medium includes a tabular conductive multilayer substrate; and at least a surface mount component mounted on the conductive multilayer substrate; the light emitting module includes at least the light source as the surface mount component.

### BACKGROUND OF THE INVENTION

1. Field of the Invention

The present invention relates to a light emitting module and the like used in the optical head of a disc recording and reproducing apparatus, which is of the system projecting an optical spot on a disc recording medium and optically recording and reproducing information.

2. Related Art of the Invention

In recent years, in general, a disc recording and reproducing apparatus has diversified its application for DVD recorders, MD, CD, and the like year by year, and has been increasingly gaining high density, miniaturization, high performance, high quality, and high-value added. Particularly, in the disc recording and reproducing apparatus utilizing a recordable medium, the demand for data and image recording has been on the rise, and miniaturization, thin-shape, high-performance, and high recording density have been ever-increasingly solicited.

With respect to the conventional technology regarding the optical head of the disc recording and reproducing apparatus, there have been many reports submitted (for example, refer to Japanese Patent Laid-Open No. 11-328683 and Japanese Patent Laid-Open No. 2003-208731).

As an example of the conventional disc recording and reproducing apparatus, an optical head for a magneto-optical disc will be described below with reference to the drawings.

In FIGS. 22A and 22B, 23A and 23B, 24, 25, 26A and 26B, and 27, reference numeral 1 denotes a silicon substrate, reference numeral 2 a semiconductor laser which is a light source fixed on the silicon substrate 1, reference numeral 3 a multisegment photodetector formed on the silicon substrate 1 by IC process, reference numeral 4 a heat radiating plate retaining the silicon substrate 1 in a heat transferring state, reference numeral 5 a terminal wired by wire bonding and the like from the output unit of the multisegment photodetector 3, reference numeral 6 a resin package retaining the silicon substrate 1, the heat radiating plate 4, and the terminal 5, reference numeral 7 a hologram element formed by resin (diffraction grating), reference numeral 8 a compound element composed of a beam splitter 8a, a folded mirror 8b, and a polarized light separation element 8c.

Further, the silicon substrate 1, the semiconductor laser 2, the multisegment photodetector 3, the heat radiating plate 4, the terminal 5, the resin package 6, the hologram element 7, and the compound element 8 are made into an integral construction, and are defined as an integrated unit 9. Reference numeral 10 denotes a reflecting mirror, reference numeral 11 an optical lens fixed to an object lens holder 12, reference numeral 13 a magneto-optical recording medium which is an information recording medium having a magneto-optical effect, reference numeral 14 an optical lens driving device to drive the optical lens 11 in a focus direction (direction substantially vertical to the information recording surface of the magneto-optical recording medium 13) and a radial direction (direction substantially parallel with the information recording surface of the magneto-optical recording medium 13) of the magneto-optical recording medium 13.

The optical lens driving device 14 is composed of parts of the optical lens 11 forming an optical spot on the information recording surface of the magneto-optical recording medium 13 by using a light flux from the semiconductor laser 1, the optical lens holder 12, a base 15, a suspension 16, a magnet 17a, a yoke 17b, a focus coil 18a, and a tracking coil 18b. By the magnet 17a, the base 15, and the yoke 17b, which are magnetic materials, a magnetic circuit is formed, and is energized to the focus coil 18a so that the optical lens 11 can be driven in the focus direction, and further, the magnetic circuit is energized to the tracking coil 18b so that the optical lens 11 can be driven in the radial direction. Reference numeral 19 denotes an optical bed plate, and the optical bed plate 19 retains the reflecting mirror 10 by adhesive bond and the like.

In the meantime, in FIG. 24, reference numeral 20 denotes an optical spot for focus error signal detection formed on the multisegment photodetector 3, reference numeral 21 an optical spot for tracking error signal detection formed on the multisegment photodetector 3, reference numeral 22 a main beam (P polarized light) formed on the multisegment photodetector 3, reference numeral 23 a main beam (S polarized light) formed on the multisegment photodetector 3, reference numeral 24 a focus error signal light receiving area, reference numerals 25 and 26 tracking error signal receiving areas, reference numeral 27 information signal receiving area, reference numeral 28 a subtracter, and reference numeral 29 an adder.

Further, in FIGS. 23A and 23B, reference numerals 30 and 31 denote focal points of the optical spots for focus signal error detection, and reference numeral 32 an optical spot formed on the magneto-optical recording medium 13.

In FIGS. 22A and 22B, 25, and 26A and 26B, reference numeral 33 denotes a cover, reference numeral 34 a bond, and reference numeral 35 a flexible circuit. Further, reference numeral 36 denotes a high frequency superimposed element, which is mounted on the flexible circuit 35, and applies modulating signals of 300 MHz to 400 MHz to the driving current of the semiconductor laser 2 at the reproducing time, and reduces the generation of laser noises due to interference with the outgoing light from the semiconductor laser 2 and the return light from the magneto-optical recording medium 13.

Referring to FIG. 25, the integrated unit 9 is fixed by adhering the optical bed plate 19 and the resin package 6. At this time, the optical disposition of the integrated unit 9 and the multisegment photodetector 3 retained by the resin package 6 inside the optical bed plate 19 is prescribed by dimensions of the optical bed plate 19 and the resin package 6 of the integrated unit 9, and each of these dimensions, as shown in FIG. 21, is designed so that the focus error signal light receiving area 24 is located approximately at the midpoint of the focus points 30 and 31 of the optical spot in a Z axial direction (optical axial direction) of the multisegment photodetector 3.

In this manner, the multisegment photodetector 3 can obtain a desired detection signal from the reflecting light from the magneto-optical recording medium 13.

FIG. 27 is a view showing circuit structures of the high frequency superimposed element 36 mounted on the flexible circuit 35 and the terminal 5 of the integrated unit 9. The distance between the high frequency superimposed element 36 and the terminals (LD & LD-GND) of the semiconductor laser 2 is preferably short. The longer the distance is, more increased is the impedance between the high frequency superimposed element 36 and the semiconductor laser 2, thereby creating a cause of noises of the semiconductor laser 2.

The operation of the conventional example as composed above will be described with reference to FIGS. 22 to 27.

The light emitted from the semiconductor laser 2 is separated into different plural light fluxes by the hologram element 7. The different plural light fluxes transmit the beam splitter 8a of the compound element 8, and is reflected by the reflecting mirror 10, and is collected as an optical spot 32 having approximately one micron in diameter on the magneto-optical recording medium 13 by the optical lens 11 fixed to the optical lens holder 12. Further, the light flux reflected by the beam splitter 8a of the compound element 8 enters a light receiving element for a laser monitor (not shown), and controls the driving current of the semiconductor laser 2.

The reflected light from the magneto-optical recording medium 13 traces a reverse route, and is reflected and separated by the beam splitter 8a of the compound element 8, and enters the folded mirror 8b and the polarized light separation element 8c.

The semiconductor laser 2 is installed so as to be parallel with the sheet surface in FIG. 23A, and the incident light is separated into the light fluxes of two mutually orthogonal polarized light components by the polarized light separation element 8c, and is incident on the information signal receiving area 27.

Further, from among the reflected lights from the magneto-optical recording medium 13, the light flux having transmitted the beam splitter 8a is separated into plural light fluxes by the hologram element 7, which are collected in the focus error signal light receiving area 24 and the tracking error signal light receiving areas 25 and 26, respectively. The focus servo is performed by a so-called SSD method, and the tracking servo is performed by a so-called push pull method.

Further, by calculating the difference between the main beam 22 comprising the P polarized light and the main beam 23 comprising the S polarized light, it is possible to detect a magneto-optical disc information signal by a differential detection method. Further, by working out the sum thereof, it is possible to detect a pre-pit signal.

As described above, since a desired detection signal is obtained from the reflected light from the magneto-optical recording medium 13, the relative positional adjustment among the semiconductor laser 2, the object lens 11, and the multisegment photodetector 3 is performed by the prescription of the dimensions of each unit in addition to the optical bed plate 19 at the designing time of the optical head.

Further, the relative inclination adjustment between the magneto-optical recording medium 13 and the object lens 11 is performed in such a manner as to retain a base 15 by external jig (not shown) and perform a skew adjustment of the object lens 11 and the magneto-optical recording medium 13. At this time, as shown in FIGS. 25 and 26A, θT denotes the adjustment in a tangential direction, and θR denotes the adjustment in a radial direction.

Further, the integrated unit 9 integrally shapes the heat radiating plate 4 formed by press and the like and the terminal 5 together with the resin package 6, and accurately fixes the silicon substrate 1 on the heat radiating plate 4 through solder or a radiating and conductive material such as silver paste and the like. Further, the unit 9 is constructed in such a manner that the hologram element 7 is adjusted on the resin package 6, and is fixed by adhesive bond and the like, and the compound element 8 is fixed on the hologram element 7 by adhesive bond and the like.

In the meantime, the semiconductor laser 2 is fixed on the silicon substrate 1 by solder or a radiating and conductive material such as silver paste and the like, and a LD-GND terminal is wired on the silicon substrate 1, and further, a LD terminal is wired on the silicon substrate 1 by wire bonding and the like. Consequently, the LD terminal and the LD-GND terminal are wired on the silicon terminal 1.

Further, the terminal 5 is wired to the output unit of the multisegment photodetector 3 by wire bonding. Further, the terminal 5 is connected to the flexible circuit 35 by solder, and by the high frequency superimposed element 36 mounted on the flexible circuit 35, the driving current of the semiconductor laser 2 is added with modulation signals.

In the integrated unit 9 of a conventional optical head, in a state in which the heat radiating plate 4 and the terminal 5 formed by sheet metal press is retained by the resin package 6, the silicon substrate 1 is mounted on the heat radiating plate 4, and the flexible circuit 35 mounted with the high frequency superimposed element 36 is wired on the terminal 5.

However, in this configuration, there has been the following problem. That is, the resin package 6, as shown in FIGS. 23A and 23B, covers the peripheries of the silicon substrate 1 and the semiconductor laser 2, and in order to secure its strength, the thickness and the height are required to be thick and high, and the outer peripheral portion has approximately a shape of leader head with the silicon substrate 1 disposed at the bottom. Because of the oversize of this resin package and the limit in the finishing accuracy of the sheet metal press composing the heat radiating plate 4, the terminal 5 and the like, to realize miniaturization and thin-shape of the integrated unit 9 becomes difficult.

Further, as described above, since the periphery of the heat radiating plate 4 is covered by the resin package 6, heat dissipation into the air from the heat radiating plate 4 becomes few. Further, since heat conductivity of the resin also becomes low, heat dissipation by conduction through the resin package 6 from the heat radiating plate 4 is difficult to be performed. Further, in the space surrounded by the resin package 6, the silicon substrate 1 is placed. Thus, there has been a problem in that temperature atmosphere of the space formed by the resin package 6 becomes high, and the temperature of the semiconductor laser 2 of the silicon substrate 1 placed in the space does not drop. The semiconductor 2 generates heat by emitting light, and if heat dissipation is not enough, the temperature rises in a static state, and the life of laser emission becomes short, thereby causing the fluctuation in the wavelength of the laser beam.

Further, in FIGS. 23A and 23B, as shown in FIG. 24, though the high frequency superimposed element 36 is provided on both ends of the multisegment photodetector 3 for electrical connection with the multisegment photodetector 3 provided on the silicon substrate 1, and uses the terminal 5 contacting the electrical portion of the flexible circuit 35, wire bonding 410 and 420 connecting the terminal 5 and a detector main body, as shown in the schematic perspective view of FIG. 28, the terminal 5 is disposed by straddling across a metal frame 400 which surrounds the periphery of the multisegment photodetector 3 by sheet metal press of a metal plate member.

The resin package 6 is also required to cover the edge portion of this metal frame 400, and as a result, has brought about the oversize of the area (height and width) of the surface including the multisegment photodetector 3.

In view of the above described conventional problems, an object of the present invention is to provide a light emitting module aiming at miniaturization, thin-shape, high performance, simplification of manufacturing process, and highly efficient radiating characteristics, and an optical head including such module, and a disc recording and reproducing apparatus and the like utilizing such module and head.

According to the present invention as described above, since the distance between the light source and a modulating signal adding device can be made short, and moreover, the both can be effectively connected, a resistance (impedance) can be made small, and the output of the modulating signal adding device can be sharply reduced, and the lowering of unnecessary radiation and heat generation as well as the lowering of power consumption can be realized, and improvement of recording and reproducing performance and sharp increase of battery life, and the light receiving and emitting element and the disc recording and reproducing apparatus excellent in heat dissipation characteristics can be realized.

Further, since it is possible to effectively transfer and dissipate the heat generation from the semiconductor laser, the temperature rise of the semiconductor laser which becomes the light source can be prevented, and it is possible to prevent deterioration of the life of the semiconductor laser, and the light receiving and emitting element and the disc recording and reproducing apparatus excellent in reliability can be realized.

Further, it is possible to sharply improve heat conductivity of a multilayer substrate, and the heat generated from the semiconductor laser which becomes the light source can be effectively transferred and dissipated, and by lowering the temperature of the semiconductor laser, the life of the semiconductor laser can be sharply prolonged, and the disc recording and reproducing apparatus excellent in reliability can be realized.

Further, it is possible to effectively transfer the heat generated from the semiconductor laser which becomes the light source to another place, whereby heat dissipation property can be more improved, and the disc recording and reproducing apparatus excellent in reliability can be realized.

Further, it is possible to realize the disc recording and reproducing apparatus more excellent in heat dissipation characteristics.

Further, since it is possible to realize much higher integration, a miniaturized disc recording and reproducing apparatus can be realized.

Further, since it is possible to protect the light source of the semiconductor laser and the like from static electricity, the disc recording and reproducing apparatus excellent in reliability can be realized.

Further, by having a static electricity relaxation function to relax a sharp potential difference generated in two electrodes of the light source due to static electricity, even in case the two electrodes of the light source are electrically non-conductive, it is possible to reduce the effect of the static electricity, and the disc recording and reproducing apparatus which is a miniaturized light receiving element and more excellent in reliability for static electricity can be realized.

Further, a disc recording and reproducing apparatus, which has few power source noise and unnecessary radiation, and moreover, is miniaturized, can be realized.

Further, since it is possible to retain the optical element much smaller and in high accuracy, a miniaturized high performance disc recording and reproducing apparatus can be realized.

Further, since it is possible to increasingly improve heat dissipation characteristics of a conductive multilayer substrate, the life of the semiconductor laser which becomes the light source can be sharply prolonged.

Further, since it is possible to make the optical head much smaller, a miniaturized disc recording and reproducing apparatus can be realized.

With the conductive multilayer substrate by ceramic and the like as described above taken as a nucleus, the semiconductor laser 2 and the high frequency superimposed element 36 are connected by a short distance without the intermediary of the flexible circuit 35, and at the same time, the conductive multilayer substrate by ceramic and the like is used, so that the silicon substrate 1 can be retained in miniaturization, thin-shape, and high accuracy, and drastic miniaturization of the light receiving and emitting element and a fully high efficiency of the high frequency superimposed element 36 can be realized.

Further, the conductive multilayer substrate such as ceramic and the like is excellent in heat transferability and heat dissipation characteristic from a point that it is excellent in heat conductivity to resin. Further, the power consumption to operate the high frequency superimposed element 36 becomes few from a point that the output of the high frequency superimposed element 36 can be lowered, so that a built-in module excellent in heat dissipation characteristics can be realized.

Since the ceramic substrate is excellent in strength comparing with resin, miniaturization and thin-shape are made possible.

With the multilayer ceramic substrate having conductivity between each layer taken as a nucleus, a light source, a light receiving element, electronic parts, a high frequency superimposition generating circuit, a laser driving circuit, optical parts, and the like are modularized, so that drastic miniaturization of a light receiving and emitting element module and a fully high efficiency of the high frequency superimposition generating circuit are made possible. Further, the conductive multilayer substrate such as ceramic and the like is excellent in heat transferability and heat dissipation characteristic from a point that it is excellent in heat transferability to resin. Further, the power consumption to operate the high frequency superimposed element 36 becomes few from a point that the output of the high frequency superimposed element 36 can be lowered, so that the light receiving and emitting element module excellent in heat dissipation characteristic can be realized, and miniaturization, thin-shape, and high reliability of the optical head can be realized, and at the same time, miniaturization, thin-shape, and high reliability of the disc recording and reproducing apparatus can be realized.

As described above, according to the present invention, an optical head excellent in heat dissipation characteristic, miniaturization as well as thin-shape, and reliability can be realized.

### SUMMARY OF THE INVENTION

The 1^{st} aspect of the present invention is a light emitting module used for an optical head having a light source and a single or plural light receiving elements and for using record or reproduce information on information recording medium, comprising:

a tabular conductive multilayer substrate; and

at least a surface mount component mounted on said conductive multilayer substrate;

said light emitting module includes at least said light source as said surface mount component.

The 2^{nd} aspect of the present invention is the light emitting module according to the 1^{st} aspect of the present invention, wherein said conductive multilayer substrates comprises a heat transfer route to transfer a heat at the side where said surface mount component is mounted to a portion other than said surface mount component.

The 3^{rd} aspect of the present invention is the light emitting module according to the 2^{nd} aspect of the present invention, wherein said heat transfer route is a via hole made from a metal or a conductive paste.

The 4^{th} aspect of the present invention is the light emitting module according to the 1^{st} aspect of the present invention, wherein said conductive multilayer substrate is composed by laminating a ceramic substrate and/or glass epoxy substrate.

The 5^{th} aspect of the present invention is the light emitting module according to the 1^{st} aspect of the present invention, comprising at least one of said light emitting elements as said surface mount component.

The 6^{th} aspect of the present invention is the light emitting module according to the 1^{st} aspect of the present invention, comprising a first heat radiator made from metal or ceramic which is provided on a surface opposing to the surface mounted with said surface mount component of said conducive multilayer substrate.

The 7^{th} aspect of the present invention is the light emitting module according to the 1^{st} aspect of the present invention, comprising a modulation signal adding device to add a modulation signal to said light source as said surface mount component.

The 8^{th} aspect of the present invention is the light emitting module according to the 7^{th} aspect of the present invention, wherein said modulation signal adding device is mounted on a surface opposing to the surface where said light source of said conductive multilayer substrate is mounted.

The 9^{th} aspect of the present invention is the light emitting module according to the 7^{th} aspect of the present invention, wherein said modulation signal adding device includes a high frequency superimposition adding device to add a high frequency superimposition operation to said light source.

The 10^{th} aspect of the present invention is the light emitting module according to the 7^{th} aspect of the present invention, wherein said modulation signal adding device includes a laser driving device to perform a multi-valued control of the light emitting power of said light source.

The 11^{th} aspect of the present invention is the light emitting module according to the 1^{st} aspect of the present invention, comprising a static protection mechanism, which makes it possible to put a space between two electrodes of said light source as said surface mount component into an electrically conductive state by solder, wiring or conductive component on said conductive multilayer substrate, and at the same time, to put a space between said two electrodes on said conductive multilayer substrate into a non-conductive state by cutting said wiring and removing said solder or said conductive part.

The 12^{th} aspect of the present invention is the light emitting module according to the 1^{st} aspect of the present invention, comprising a first passive element as said surface mount component having a static electricity alleviation function to alleviate a potential difference generated in two electrodes of said light source.

The 13^{th} aspect of the present invention is the light emitting module according to the 5^{th} aspect of the present invention, comprising a second passive element as said surface mount component inserted into the power supply line or the signal line of said passive element, and having a noise removal function to remove a noise generated in said power supply line or the signal line.

The 14^{th} aspect of the present invention is the light emitting module according to the 7^{th} aspect of the present invention, comprising a third passive element as said surface mount component having a filter function to shut off or let pass through the signal of a specific frequency band leaked from said modulation signal adding device.

The 15^{th} aspect of the present invention is the light emitting module according to the 1^{st} aspect of the present invention, wherein said surface mount component has:

light emission quantity detection means to detect the light emission quantity of said light source; and

adjustment means to accept the adjustment of detection sensitivity of said light emission amount detection means on said conductive multilayer substrate.

The 16^{th} aspect of the present invention is the light emitting module according to the 1^{st} aspect of the present invention, comprising a second heat radiator provided on the front surface or the side surface of said conductive multilayer substrate.

The 17^{th} aspect of the present invention is the light emitting module according to the 16^{th} aspect of the present invention, wherein said second heat radiator is disposed at a position so as to be substantially opposed to the main surface of said information recording medium.

The 18^{th} aspect of the present invention is the light emitting module according to the 1^{st} aspect of the present invention, wherein said light source is two or more light sources having different wavelengths.

The 19^{th} aspect of the present invention is the light emitting module according to the 1^{st} aspect of the present invention, comprising a single or plural optical elements as said surface mount component to form a light path connecting said light source and/or said light receiving element and at least said object lens.

The 20^{th} aspect of the present invention is the light emitting module according to the 1^{st} aspect of the present invention, wherein said surface mount component is fixed to said conductive multilayer substrate by silver paste or solder in a heat transfer and conductive state.

The 21^{st} aspect of the present invention is the light emitting module according to the 1^{st} aspect of the present invention, wherein said conductive multilayer substrate and said surface mount component are wired by metal wire or bump.

The 22^{nd} aspect of the present invention is the light emitting module according to the 21^{st} aspect of the present invention, wherein said metal wire and connecting portions of said metal wire or connecting portions of said bump are sealed by sealant comprising resin, silicon rubber or adhesive agent.

The 23^{rd} aspect of the present invention is the light emitting module according to the 22^{nd} aspect of the present invention, wherein a portion of said conductive multilayer substrate has a step, and said step is provided with said metal wire or said metal wire connecting portion, and the connecting portion of said bump is provided with stored sealant of said sealant.

The 24^{th} aspect of the present invention is the light emitting module according to the 1^{st} aspect of the present invention, comprising an unevenness provided on the surface of said conductive multilayer substrate for positioning or retaining said surface mount component or said conductive multilayer substrate.

The 25^{th} aspect of the present invention is the light emitting module according to the 1^{st} aspect of the present invention, comprising electrodes provided on the side surface of said conductive multilayer substrate.

The 26^{th} aspect of the present invention is an optical head, comprising:

a light source;

an object lens letting enter a light flux from said light source and collecting it on information recording medium;

an object lens driving device driving said object lens in a focus direction and a tracking direction of said information recording medium;

a single or plural light receiving elements receiving a light flux having reflected by said information recording medium and transmitted said object lens to generate the current based on said light quantity received, and
said optical head having at least said light source as the light emitting module according to the 1^{st} aspect of the present invention.

The 27^{th} aspect of the present invention is the light emitting module according to the 26^{th} aspect of the present invention, comprising a current voltage converter to convert the current generated by said light receiving element into voltage and an amplifier to amplify said current or said voltage.

The 28^{th} aspect of the present invention is the optical head according to the 26^{th} aspect of the present invention, comprising an arithmetic circuit detecting the value of said current or voltage and generating a part of the servo signal or the servo signal of said object lens driving device.

The 29^{th} aspect of the present invention is the optical head according to the 26^{th} aspect of the present invention, comprising an arithmetic circuit detecting the value of said current or voltage and reading the recording signal on said information recording medium.

The 30^{th} aspect of the present invention is a manufacturing method of the light emitting module according to the 1^{st} aspect of the present invention, comprising the steps of:

wiring the surface mount components on the main surface of the conductive multilayer substrate having the wiring inside each layer, between layers or on the surface by metal wire or bump wire, and dividing a predetermined portion of said conductive substrate body.

The 31^{st} aspect of the present invention is an optical disc recording and reproducing apparatus, comprising;

the optical head according to the 26^{th} aspect of the present invention, and

information recording/reproducing means to perform the recording or reproducing of information from information recording medium by said optical head.

### BRIEF DESCRIPTION OF THE DRAWINGS

FIG. 1A is an exploded oblique view of an optical head according to a first embodiment of the present invention;

FIG. 1B is a partial oblique view of the structure of the optical head according to the first embodiment of the present invention;

FIG. 2A is a view showing the outline of the optical path view of the optical head according to the first embodiment of the present invention;

FIG. 2B is a view showing the outline of the optical path view of the optical head according to the first embodiment of the present invention;

FIG. 2C is a block diagram showing other example of the structure of the optical head according to the first embodiment of the present invention;

FIG. 3A is an exploded oblique view of the object lens driving apparatus of the optical head according to the first embodiment of the present invention;

FIG. 3B is an oblique view of the optical head according to the first embodiment of the present invention;

FIG. 4 is a block diagram showing a multisegment photodetector and a signal detection circuit of the optical head according to the first embodiment of the present invention;

FIG. 5A is a block diagram showing the structure of the light receiving and emitting element module of the optical head according to the first embodiment of the present invention;

FIG. 5B is a block diagram showing the structure of the light receiving and emitting element module of the optical head according to the first embodiment of the present invention;

FIG. 5C is a block diagram showing the structure of the light receiving and emitting element module of the optical head according to the first embodiment of the present invention;

FIG. 6A is an oblique view of the light receiving and emitting element module of the optical head according to the first embodiment of the present invention;

FIG. 6B is an oblique view of the light receiving and emitting element module of the optical head according to the first embodiment of the present invention;

FIG. 7A is a block diagram showing the structure of the light receiving element module and the flexible circuit of the optical head according to the first embodiment of the present invention;

FIG. 7B is a block diagram showing the structure of the light receiving element module and the flexible circuit of the optical head according to the first embodiment of the present invention;

FIG. 7C is a block diagram showing the structure of the light receiving element module and the flexible circuit of the optical head according to the first embodiment of the present invention;

FIG. 8 is a circuit diagram showing a wiring state between the light receiving and emitting element module and the flexible circuit according to the first embodiment of the present invention;

FIG. 9A is a block diagram showing the structures of the light receiving and emitting element module and the flexible circuit of the optical head according to the first embodiment of the present invention;

FIG. 9B is a block diagram showing the structures of the light receiving and emitting element module and the flexible circuit of the optical head according to the first embodiment of the present invention;

FIG. 9C is a block diagram showing the structures of the light receiving and emitting element module and the flexible circuit of the optical head according to the first embodiment of the present invention;

FIG. 10 is a block diagram showing a sample of the recording power waveform of the optical head according to the first embodiment of the present invention;

FIG. 11 is a block diagram showing a wiring between the light receiving and emitting element module and the flexible circuit of the optical head according to a second embodiment of the present invention;

FIG. 12A is a block diagram showing the structure of the light receiving and emitting element module of the optical head according to the second embodiment of the present invention;

FIG. 12B is a block diagram showing the structure of the light receiving and emitting element module of the optical head according to the second embodiment of the present invention;

FIG. 12C is a block diagram showing the structure of the light receiving and emitting element module of the optical head according to the second embodiment of the present invention;

FIG. 13A is an oblique view of the light receiving and emitting element module of the optical head according to the second embodiment of the present invention;

FIG. 13B is an oblique view of the light receiving and emitting element module of the optical head according to the second embodiment of the present invention;

FIG. 14A is a block diagram showing the wiring between the light receiving and emitting element module of the optical head and the flexible circuit 35 according to a third embodiment of the present invention;

FIG. 14B is a circuit diagram showing a light receiving element for laser monitor and a gain adjustment mechanism according to a third embodiment of the present invention;

FIG. 15A is an oblique view of the light receiving and emitting element module of the optical head according to the third embodiment of the present invention;

FIG. 15B is an oblique view of the light receiving and emitting element module of the optical head according to the third embodiment of the present invention;

FIG. 16A is an oblique view of the light receiving and emitting element module of the optical head according to a fourth embodiment of the present invention;

FIG. 16B is an oblique view of the light receiving and emitting element module of the optical head according to a fourth embodiment of the present invention;

FIG. 17 is a view showing the outline of the optical path view of the optical head according to a fifth embodiment of the present invention;

FIG. 18A is an oblique view of the light receiving and emitting element module of the optical head according to a sixth embodiment of the present invention;

FIG. 18B is an oblique view of the light receiving and emitting element module of the optical head according to a sixth embodiment of the present invention;

FIG. 19A is an oblique view of the light receiving and emitting element module of the optical head according to a seventh embodiment of the present invention;

FIG. 19B is an oblique view of the light receiving and emitting element module of the optical head according to a seventh embodiment of the present invention;

FIG. 20A is a view showing a manufacturing process of the light receiving and emitting element module of the optical head according to each embodiment of the present invention;

FIG. 20B is a view showing a manufacturing process of the light receiving and emitting element module of the optical head according to each embodiment of the present invention;

FIG. 20C is a view showing a manufacturing process of the light receiving and emitting element module of the optical head according to each embodiment of the present invention;

FIG. 21 is a view showing the structure of an optical disc recording and reproducing apparatus according to the embodiments of the present invention;

FIG. 22A is an exploded oblique view of the object lens driving apparatus of a conventional optical head;

FIG. 22B is an oblique view of the conventional optical head;

FIG. 23A is a view showing the outline of the optical path view of the conventional optical head;

FIG. 23B is a view showing the outline of the optical path view of the conventional optical head;

FIG. 24 is a block diagram showing the multisegment optical detector and a signal detection circuit of the conventional optical head;

FIG. 25 is an exploded oblique view of the conventional optical head;

FIG. 26A is an exploded oblique view of the conventional optical head;

FIG. 26B is a view showing its adjustment method;

FIG. 27 is a block diagram showing the wiring of the conventional optical head; and

FIG. 28 is a schematic perspective view of the vicinity of a resin package 6 of the conventional optical head.

### DESCRIPTION OF SYMBOLS

1 SILICON SUBSTRATE
2 SEMICONDUCTOR LASER
2a LD TERMINAL
2b LD-GND TERMINAL
3 MULTISEGMENT PHOTODETECTOR
4 HEAT DISSIPATION PLATE
5 TERMINAL
6 RESIN PACKAGE
7 HOLOGRAM ELEMENT (DIFFRACTION GRATING)
8 COMPOUND ELEMENT
8a BEAM SPLITTER
8b FOLDED MIRROR
8c POLARIZED LIGHT SEPARATION ELEMENT
9 INTEGRATED UNIT
10 REFLECTING MIRROR
11 OBJECT LENS
12 OBJECT LENS HOLDER
13 MAGNETO-OPTICAL RECORDING MEDIUM
14 OBJECT LENS DRIVING DEVICE
15 BASE
16 SUSPENSION
17a MAGNET
17b COVER
18a FOCUS COIL
18b TRACKING COIL
19 OPTICAL BED PLATE
20 OPTICAL SPOT FOR FOCUS ERROR SIGNAL DETECTION
21 OPTICAL SPOT FOR TRACKING ERROR SIGNAL DETECTION
22 OPTICAL SPOT OF MAIN BEAM (P POLARIZED LIGHT)
23 OPTICAL SPOT OF MAIN BEAM (S POLARIZED LIGHT)
24 FOCUS ERROR SIGNAL LIGHT RECEIVING AREA
25, 26 TRACKING ERROR SIGNAL LIGHT RECEIVING AREA
27 INFORMATION SIGNAL LIGHT RECEIVING AREA
28 SUBTRACTER
29 ADDER
30, 31 FOCAL POINT OF OPTICAL SPOT
32 OPTICAL SPOT
33 COVER
34 ADHESIVE AGENT
35 FLEXIBLE CIRCUIT
36 HIGH FREQUENCY SUPERIMPOSITION GENERATING CIRCUIT
44 SEMICONDUCTOR LASER DRIVING CIRCUIT
45 POSITIONING HOLE
46 FOLDED MIRROR
50 MULTILAYER CERAMIC SUBSTRATE
50a CERAMIC SUBSTRATE
51 CONDUCTIVE LAYER
52 HEAT TRANSFER PAD
53 HEAT DISSIPATION PAD
54 VIA HOLE
55a PAD
55b PAD
56 HIGH FREQUENCY SUPERIMPOSITION GENERATING CIRCUIT
57 SOLDER
58 SILVER PASTE
59 OUTPUT TERMINAL
60 WIRE BONDING
61 ANTI-STATIC ELECTRICITY FILTER
62 LIGHT RECEIVING AND EMITTING ELEMENT MODULE
63 LIGHT RECEIVING ELEMENT FOR LASER MONITOR
64 HIGH FREQUENCY FILTER
65 NOISE REDUCTION CONDENSER
66 GAIN ADJUSTMENT MECHANISM
67 HEAT DISSIPATION FIN
68 SEMICONDUCTOR LASER a
69 SEMICONDUCTOR LASER b
70 OPTICAL ELEMENT
71 REFLECTING MIRROR
72 HOLOGRAM

### PREFERRED EMBODIMENTS OF THE PRESENT INVENTION

The present invention will be described below in detail by using the drawings.

### First Embodiment

A first embodiment of the present invention will be described below with reference to the drawings.

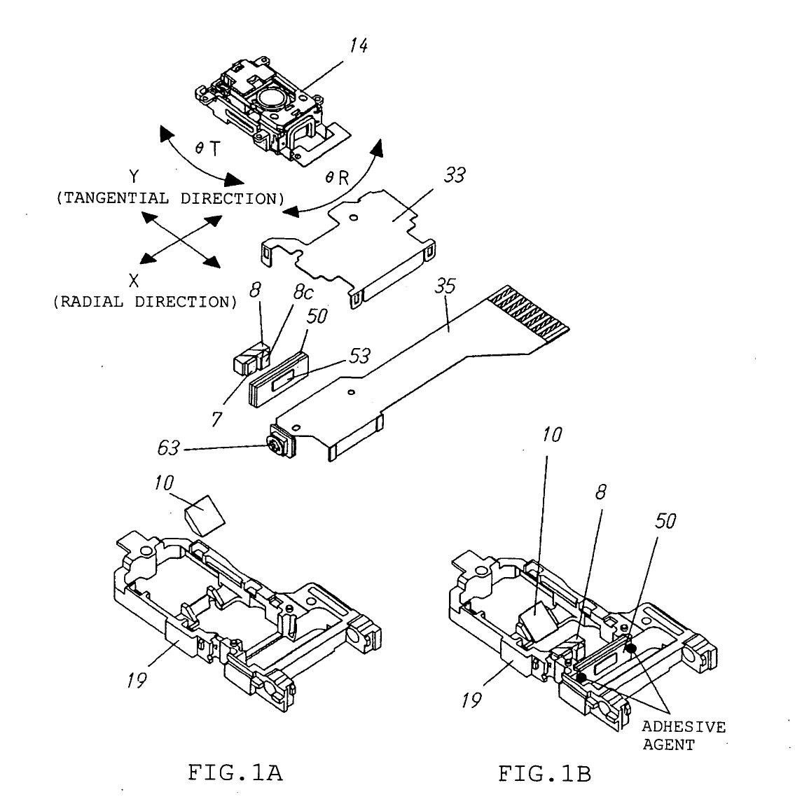

FIGS. 1, 2, 3, 4, 5, 6, 7, and 8 are block diagrams of the optical head of a first embodiment of the present invention and each unit constituting the optical head.

FIG. 1A is an exploded oblique view of the optical head, and FIG. 1B is its partial view.

In FIG. 1A, reference numeral 14 denotes an object lens driving device to drive an object lens 11 in focus and radial directions of a magneto-optical recording medium 13.

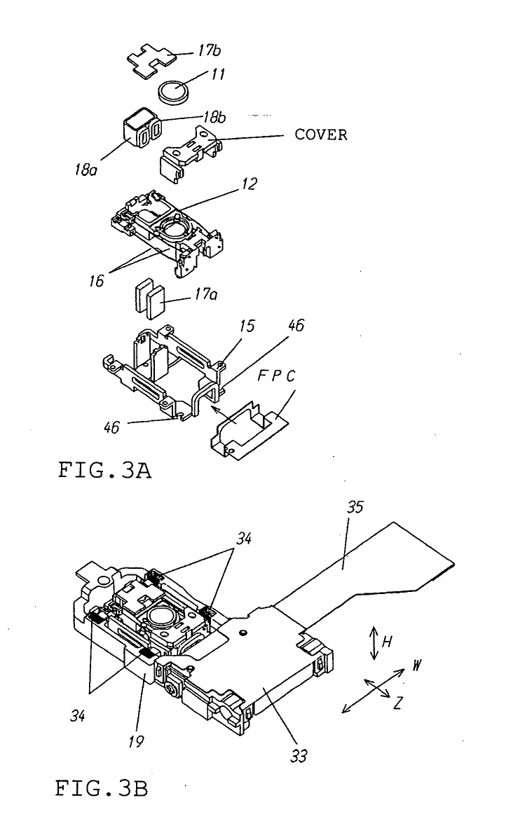

FIG. 3A is an exploded oblique view of the object lens driving device 14, and FIG. 3B is an oblique view showing its mounting state inside the optical head. As shown in FIG. 3A, the object lens driving device 14 is composed of parts of the optical lens 11 forming an optical spot on a magneto-optical recording medium 13 by using a light flux from a semiconductor laser 1, an optical lens holder 12, and a base 15, a suspension 16, a magnet 17a, a cover 17b, a yoke 17b, a focus coil 18a, a tracking coil 18b. By the magnet 17a, the base 15, which are magnetic materials, and the cover 17b, a magnetic circuit is formed, and is energized to the focus coil 18a, so that the optical lens 11 can be driven in the focus direction, and further, the magnetic circuit is energized to the tracking coil 18b, so that the optical lens 11 can be driven in the radial direction. Reference numeral 19 denotes an optical bed plate, and as shown in FIG. 1B, the optical bed plate 19 retains a reflecting mirror 10 therein by means of adhesion bond and the like.

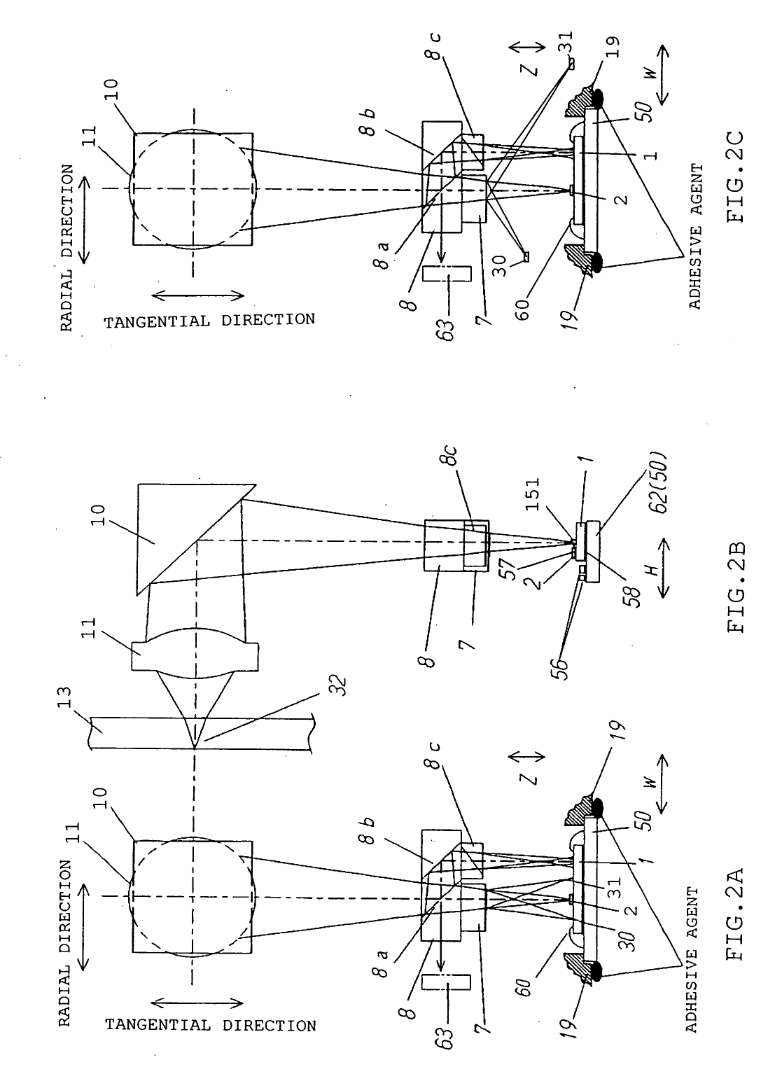

Further, FIGS. 2A and 2B are two views showing each unit composing the optical head along optical disposition. In FIGS. 2A and 2B, reference numeral 1 denotes a silicon substrate, reference numeral 2 a semiconductor laser fixed on the silicon substrate 1, reference numeral 3 a multisegment photodetector formed on the silicon substrate 1, reference numeral 50 a multilayer ceramic substrate to dispose the silicon substrate 1 on its main surface, reference numeral 151 a folded mirror, reference numeral 7 a hologram element (diffraction grating) molded by glass or resin, reference numeral 8 a compound element composed of a beam splitter 8a, a folded mirror 8b, and a polarized light separation element 8c, reference numeral 10 a reflecting mirror, reference numeral 11 an object lens fixed to the object lens holder 12, and reference numeral 13 a magneto-optical recording medium having a magneto-optical effect.

In the above described configuration, a module composed of the silicon substrate 1, the semiconductor laser 2, the multisegment photodetector 3, the multilayer ceramic substrate 50, and the folded mirror 151 is defined as a light receiving and emitting element module 62.

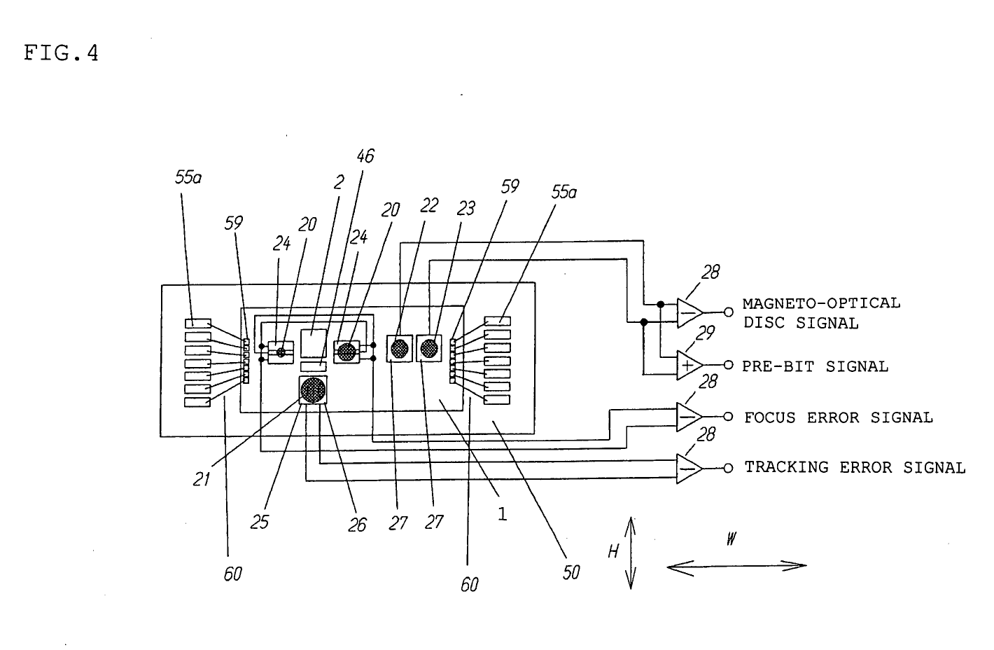

In the meantime, FIG. 4 is a top plan view showing the configuration of the multisegment photodetector 3 and a signal detection circuit to detect a signal from thereof. In FIG. 4, reference numeral 20 denotes an optical spot for focus error signal detection formed on the multisegment photodetector 3, reference numeral 21 an optical spot for tracking error signal detection formed on the multisegment photodetector 3, reference numeral 22 a main beam (P polarized light) formed on the multisegment photodetector 3, reference numeral 23 a main beam (S polarized light) formed on the multisegment photodetector 3, reference numeral 24 a focus error signal light receiving area in which an optical spot 20 for the focus error signal detection is formed, reference numerals 25 and 26 tracking error signal light receiving areas in which an optical spot 21 for the tracking error signal detection is formed, reference numeral 27 information signal light receiving area in which the optical spots 22 and 23 of the main beams are formed, reference numeral 28 a subtracter, and reference numeral 29 an adder.

The subtracter 28 and the adder 29 may be provided inside the multisegment photodetector 3 or mounted on a servo circuit unit (external circuit and not shown) connected from the optical head.

Further, the signals inputted to the subtracter 28 and the adder 29 may be current signals generated at each light receiving and emitting unit according to the quantity of the incident light or signals after converted into voltage signals by providing a current voltage converter (so-called I/V converter).

Further, the signals inputted to the subtracter 28 and the adder 29, regardless of the current signal and the voltage signal of the size at each light receiving area detecting time, may be changed in the signal quantity by an amplifier (amplification or attenuation of the signal). Further, the current voltage converting circuit and the amplifier may be provided inside the multisegment photodetector 3 and at other places on the multilayer ceramic substrate 50, or may be mounted in the servo circuit unit (external circuit and not shown) connected from the optical head. At this time, the signals outputted from the current voltage converter and the amplifier are processed in the servo circuit unit as the focus error signal and the tracking error signal. Further, the signals outputted from the subtracter 28 and the adder 29 may be processed by an arithmetic circuit as the optical disc signal and the pre-bit signal. At this time, the arithmetic circuit may be disposed inside the multisegment photodetector 3 and at other places on the multilayer ceramic substrate 50.

Further, as shown in FIGS. 1B and 2A, the light receiving and emitting element module 62 is fixed by adhering the optical bed plate 19 and the ceramic substrate 50 by adhesive agent such as a UV adhesive agent or an epoxy adhesive agent and the like. At this time, the dimension of the optical bed plate 19, the position in the Z-axis direction (optical axis direction) of the multisegment photodetector 3 is prescribed in advance so that the focus error signal light receiving area 24 is positioned approximately at a midpoint of the focal points 30 and 31.

In FIGS. 1A and 3B, reference numeral 33 denotes a cover to cover the light receiving and emitting element module 62 fixed inside the optical bed plate 19, the compound element 8, and the diffraction grating 7, reference numeral 34 an adhesive agent to fix the optical lens driving device 14 to the optical bed plate 19, reference numeral 35 a flexible circuit to electrically connect the light receiving and emitting element module 62 and an unillustrated external circuit or the like.

Further, in FIG. 2A, the light emitting optical axis of the semiconductor laser 2 is directed to a direction parallel with the sheet surface, and changes the optical axis reflected by the folded mirror 46 by 90 degrees (near side for the sheet surface in FIG. 2A). The folded mirror 46 may be formed as a reflective coat on the silicon substrate 1 by etching or may be formed as a reflective coat on the surface of glass or resin, which is adhered on the silicon substrate 1 by the adhesive agent and the like.

Further, in FIGS. 1 and 2, reference numeral 63 denotes a light receiving monitor to detect the emission quantity of the semiconductor laser 2, which has a gain adjustment volume, and performs a light quantity control of the semiconductor laser 2 based on the light quantity detected by a light receiving element 63 for a laser monitor.

In FIG. 3, the object lens driving device 14 is composed of parts of the optical lens 11 forming an optical spot on the magneto-optical recording medium 13 by using a light flux from a semiconductor laser 1, an optical lens holder 12, the base 15, a suspension 16, a magnet 17a, a cover 17b, a focus coil 18a, and a tracking coil 18b. By the magnet 17a, the base 15 and the base 17b which are magnetic materials, the magnetic circuit is constituted, and is energized to the focus coil 18a, so that the optical lens 11 can be driven in the focus direction, and further, the magnetic circuit is energized to the tracking coil 18b, so that the optical lens 11 can be driven in the radial direction.

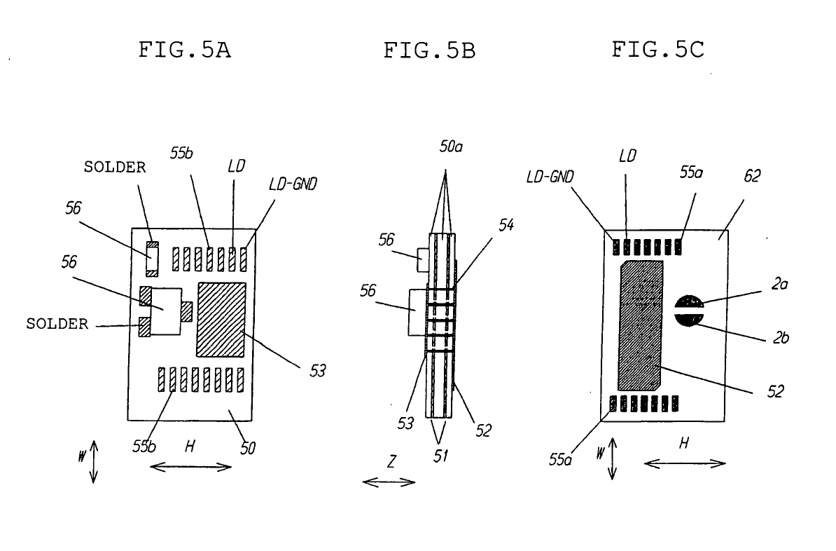

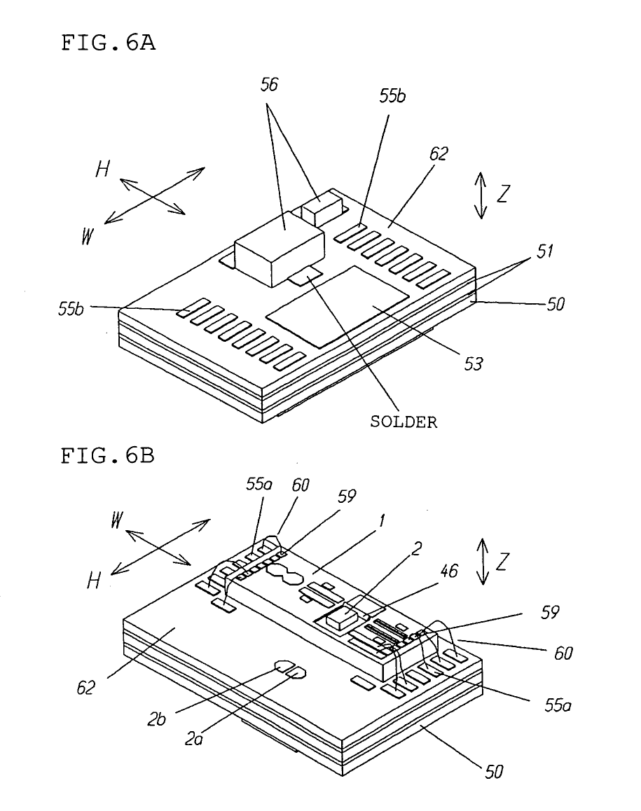

Further, FIGS. 5A to 5C are three views of the multilayer ceramic substrate 50 in the light receiving and emitting element module 62 and the circuit structure mounted thereon, and FIGS. 6A and 6B are oblique view showing both surfaces thereof.

The multilayer ceramic substrate 50 has a conductive layer 51, which is composed of a ceramic substrate 50a having two or more layers (three layers in the Figure) and a metal foil such as copper or gold provided between the layers of each ceramic substrate 50a.

Further, one main surface of the multilayer ceramic substrate 50 is formed with a heat transfer pad 52 to fix the silicon substrate 1 in a heat transferring and conductive state, and the opposite surface thereof is formed with a heat dissipating pad 53. The heat transfer pad 52 and the heat dissipating pad 53 are connected in a heat transferring and conductive state by via holes 54 composed of metal such as copper or gold and the like.

Further, the surface mounted with the silicon substrate 1 is formed with plural pads 55a, and the opposite surface is formed with plural pads 55b. The pads 55a and 55b are connected in a heat transferring and conductive state respectively through the conductive layer 51 of each layer inside the multilayer ceramic substrate 50.

As described above, the multilayer ceramic substrate 50 has a heat transferring path cum signal wiring between each layer, inside each layer surface and main and opposite surfaces, and is electrically connected to the multisegment photodetector 3 on the silicon substrate 1 and other components.

Further, as shown in FIGS. 5B and 6A, the surface of the multilayer ceramic substrate 50 at the side where the silicon substrate 1 is not mounted is mounted with a high frequency superimposition generating circuit 56 which is composed of a condenser, a resister, a coil, a filter composed of beads and the like, an inductor, a transistor, an integrated circuit, an oscillator and the like (detailed circuit to add modulation to the semiconductor laser 2 is not shown), so that the driving current of the semiconductor laser 2 is added with the modulating signal of several hundreds MHz (to the extent of 200 MHz to 600 MHz), and a noise generated by interference between the outgoing light from the semiconductor laser 2 and the reflected light from the magneto-optical recording medium 13 is reduced.

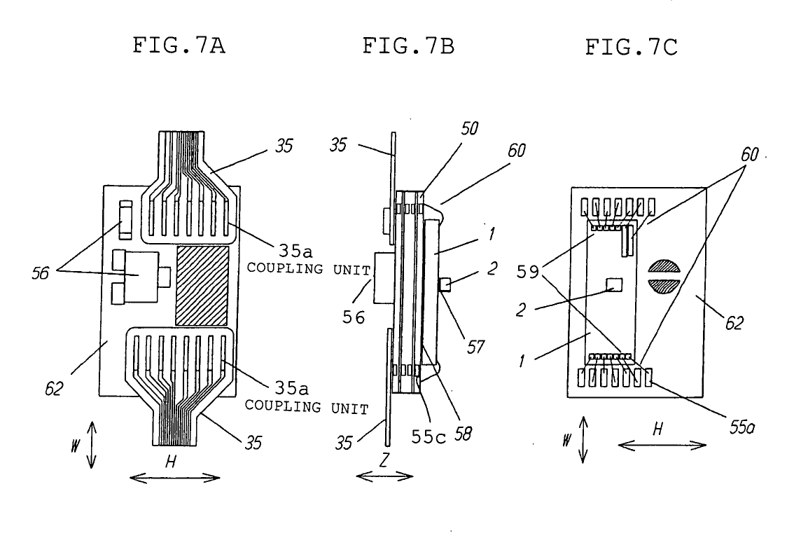

Here, FIGS. 7A to 7C are three views showing a mounting state of the multisegment photodetector 3 in the light receiving and emitting element module 62 on the silicon substrate 1 of the semiconductor laser 2 and other mounting states.

As shown in FIG. 7B, the semiconductor laser 2 is fixed on the silicon substrate 1 by solder 57. Further, the silicon substrate 1 is fixed on the multilayer ceramic substrate 50 by silver paste 58 (a kind of a conductive adhesive agent, which includes a constant quantity of silver in epoxy resin and is fixed by applying heat) in a conductive and heat transferring state. As shown by FIG. 7C, the output terminal 59 and the pad 55a provided on the silicon substrate 1 are connected by wire bonding 60 which is a metallic wire so as to be electrically connected to the wiring inside the multilayer ceramic substrate 50. At this time, in general, the wire bonding 60 uses a gold wire. Means of electrically connecting the output terminal 58 and the pad 55 is not limited to this, and may be a method of connecting by a method of bump and the like in place of the wire bonding 60.

Further, FIG. 7A shows a connecting state of a coupling unit of the flexible circuit 35 and the pad 55b provided on the multilayer ceramic substrate 50 shown in FIGS. 5A and 6A. The coupling unit 35a and the pad 55b correspond to each other one for one, so that the electrical connection is obtained. In the present embodiment, though the connection is made by solder, the connection may be made by a method such as bump, ultrasonic fusion, conductive adhesive agents, thermal fusion, and the like.

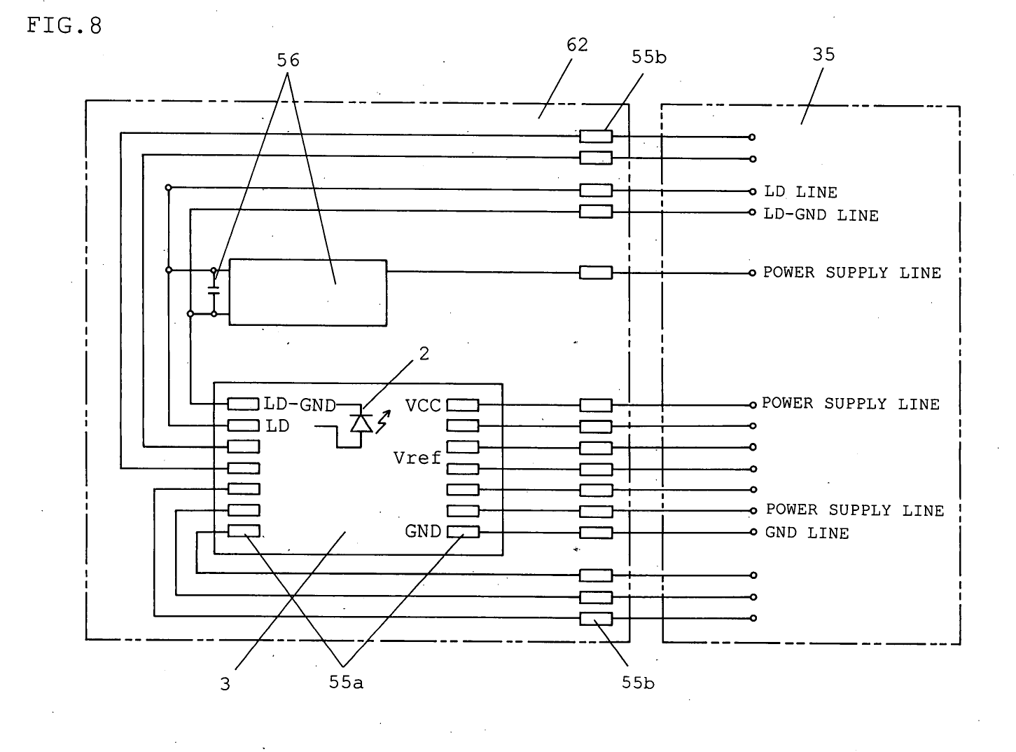

Further, FIG. 8 is a circuit diagram in which the configurations shown in FIGS. 7A to 7C are schematically illustrated, thereby showing a state of the wiring connected from the pad 55b to the flexible circuit 35 through the input out of the semiconductor laser 2 of the light receiving and emitting element module 62 and the output terminal 59 of the multisegment photodetector 3 as well as the inner wiring of the multilayer ceramic substrate 50 from the pad 55a. Though the detailed configuration of the high frequency superimposition generating circuit 56 is not shown, if it is composed of a filter composed of a condenser, a resister, a coil, beads and the like, an inductor, a transistor, an integrated circuit, an oscillator and the like, it does not matter whatever configuration it is, and though a condenser is partially shown in FIG. 8, if it satisfies the performance, it does not matter whatever electronic component can be used.

In the above described configuration, the semiconductor laser 2 is equivalent to the light source of the present invention, and the focus error signal light receiving area 24, the tracking error signal light receiving areas 25 and 26, and the information signal light receiving area 27 are equivalent to the light receiving element of the present invention. The multilayer ceramic substrate 50 is equivalent to the conductive multilayer substrate of the present invention, and the light receiving and emitting element module 62 is equivalent to the light emitting module of the present invention.

Further, the conductive layer 51, the via hole 54, the pads 55a and 55b are equivalent to the heat transfer path of the present invention, and the heat dissipation pad 53 is equivalent to the first heat radiator of the present invention.

Further, the subtracter 28 and the adder 29 are equivalent to the arithmetic circuit of the present invention, and a current voltage converter to convert the signal inputted to the subtracter 28 and the adder 29 into the voltage signal is equivalent to the current voltage converter of the present invention, and an amplifier to amplify the signal inputted to the subtracter 28 and the adder 29 is equivalent to the amplifier of the present invention.

With respect to the first embodiment of the present invention thus configured, its operation will be described below.

When the semiconductor laser 2 emits alight to perform the recording or the reproducing operation, the differential energy between the power consumed there and the actual emission quantity becomes heat, so that heat is generated. In general, the life of the semiconductor laser 2 becomes shorter as the operating temperature becomes higher, and in general, when the laser emitting an infrared light exceeds 80° C. or 90° C. in operating temperature, it sharply becomes short-lived, and when wavelength becomes still shorter, there is a tendency of the critical temperature becoming lower.

At this time, in the first embodiment, the heat generation of the semiconductor laser 2 is transferred to the solder 57, the silicon substrate 1, the silver paste 58, the heat transfer pad 52 on the multilayer ceramic substrate 50, the via holes 54, the heat dissipation pad 53, and the multilayer ceramic substrate 50, and is dissipated into the air from the heat dissipating pad 53 and the multilayer ceramic substrate 50. Alternatively the heat generation is transferred to the flexible circuit 35 mounted on the multilayer ceramic substrate 50 and the optical bed plate 19, and after that, is dissipated into the air.

The heat transferability of the multilayer ceramic 50 is adjustable to 1 W/m·k to 100 W/m·k by changing the a proportion of amounts of glass, aluminum, mineral, metal, and the like in material, and it is possible to secure heat transfer and heat dissipation characteristics corresponding to the cost of material and use application.

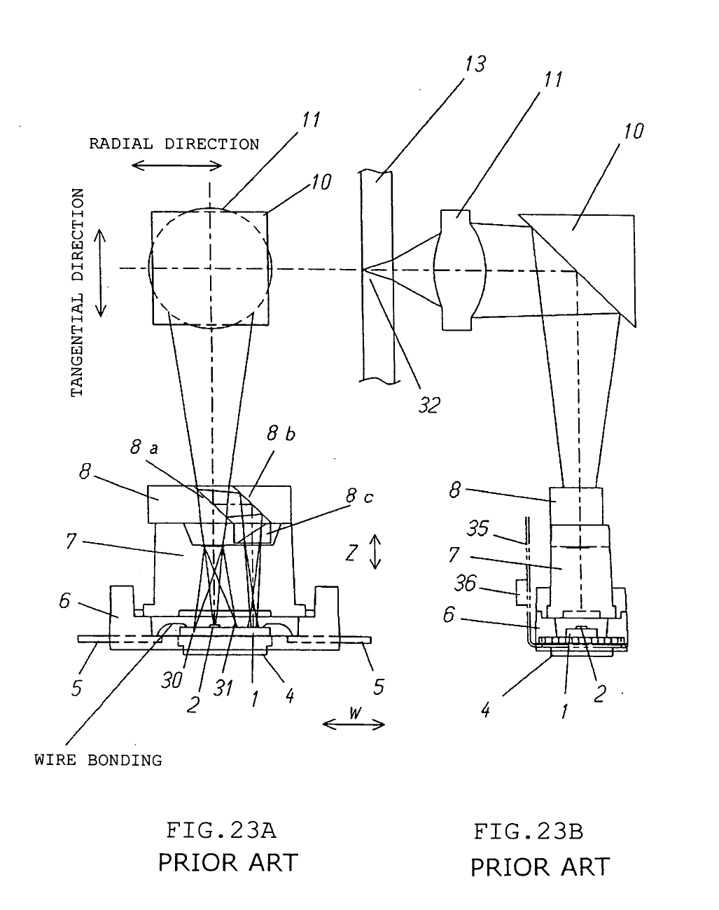

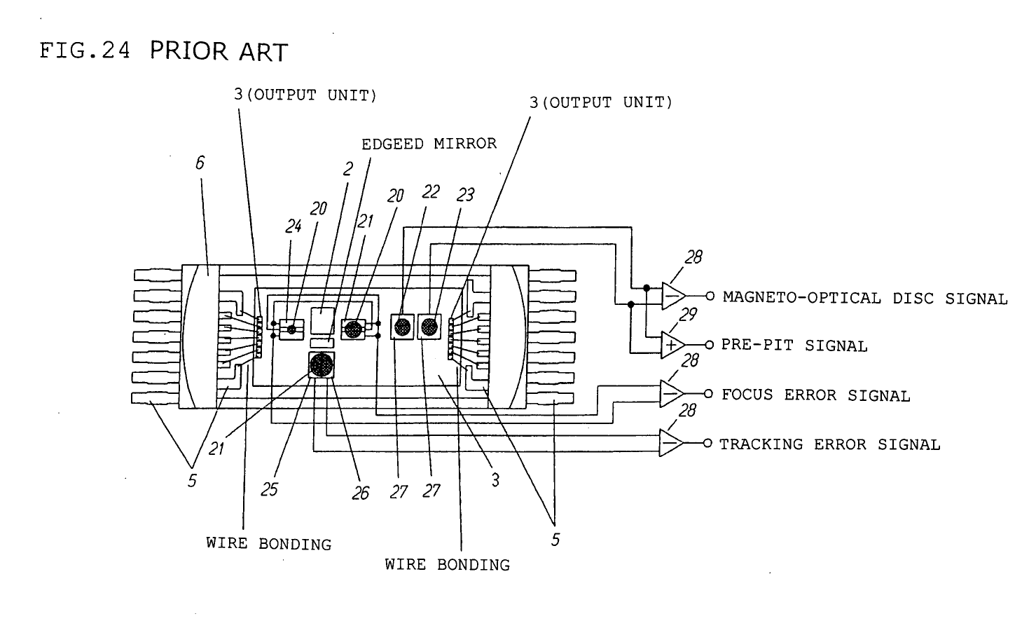

In the conventional example shown in FIG. 23 and so on, though the heat generation of the semiconductor laser 2 reaches a heat radiating plate 4 through the silicon substrate 1 having been mounted on the plate 4, the heat radiating plate 4, the silicon substrate 1, and other components are poor in heat transferability, and are surrounded in by resin package 6 made of resin, and therefore, either of heat dissipation into the air and heat transfer to other parts has not been possible to be sufficiently performed.

In contrast to this, in the present embodiment, the semiconductor laser 2 and the silicon substrate 1 are mounted and integrated on a tabular multilayer ceramic substrate 50 excellent in heat transferability as the light receiving and emitting element module 62, and moreover, are directly exposed and contacted to the outside or the side of the optical bed plate 19 through the pads 55a and 55b, the via hole 54, the conductive layer 51, the heat dissipation pad 53, and the like, all of which are comprised of the member such as metal and the like excellent in heat transferability. In this manner, heat transfer characteristics can be secured either between the layers or inside the layers, and therefore, quick heat dissipation and heat transfer are realized.

Further, the present embodiment is characterized in that the light receiving and emitting element module 62 uses the multilayer ceramic substrate 50 having electrical wirings in the inside thereof, and the high frequency superimposition generating circuit 56 is mounted on the multilayer ceramic substrate 50.

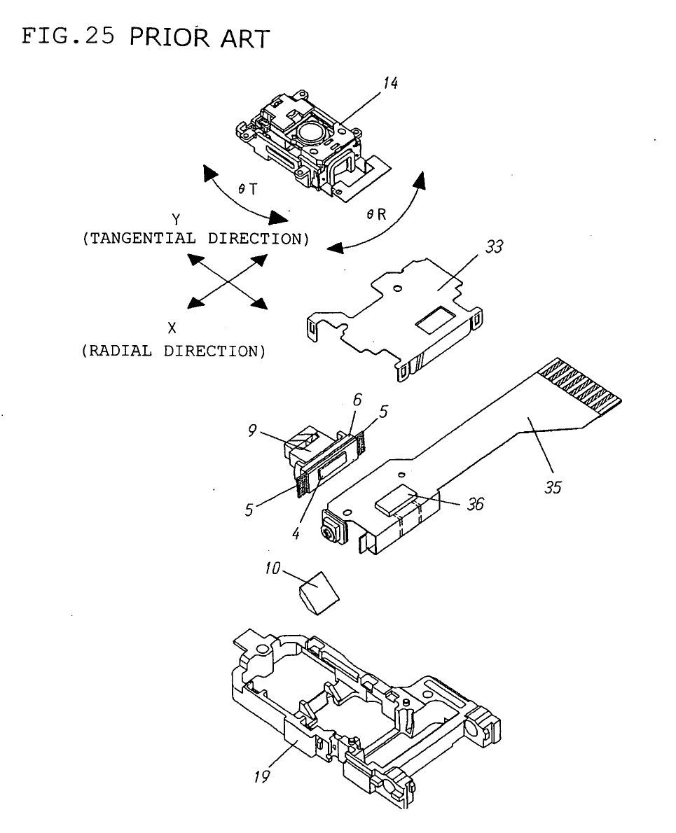

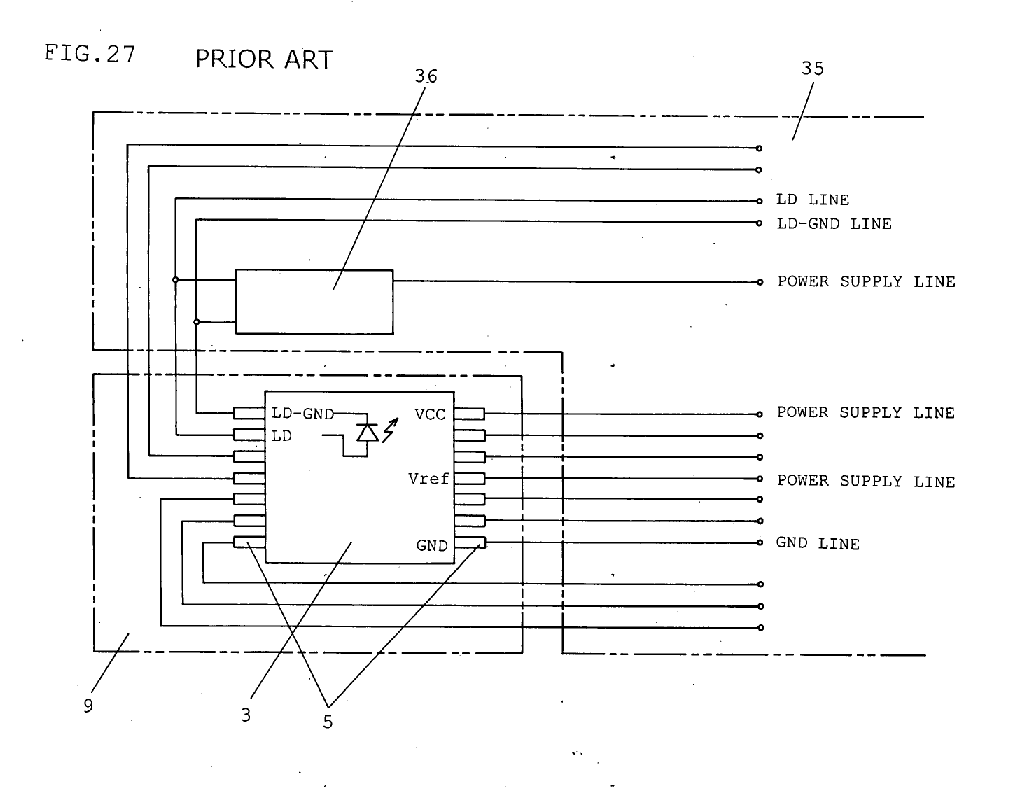

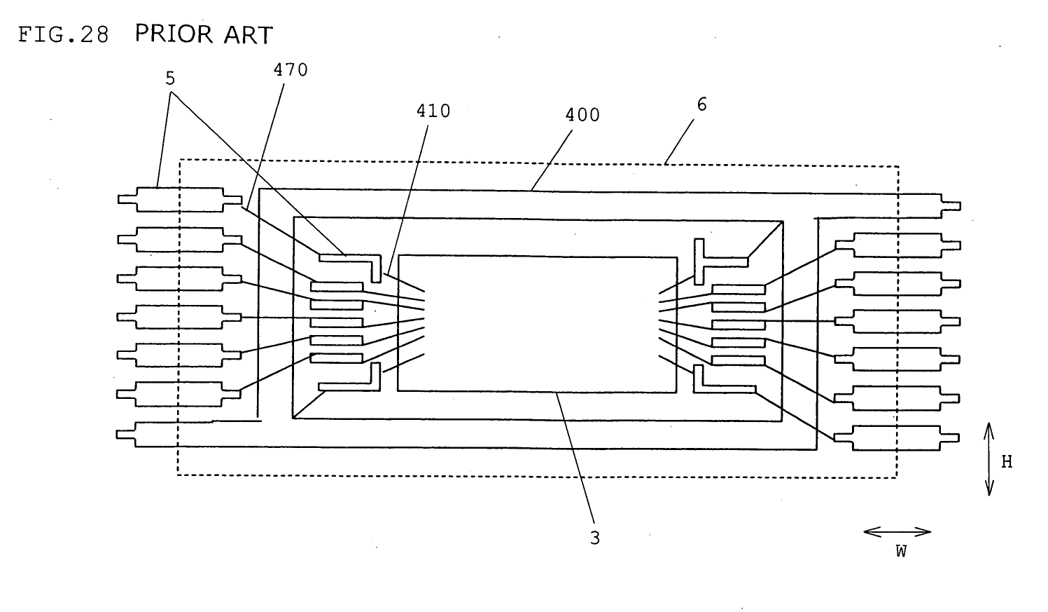

In the conventional example, the connection between the high frequency superimposition element 36 and the semiconductor laser 2 shown in FIG. 27, as actually shown in FIG. 25, is made through the flexible circuit 35, and therefore, the resistance (impedance) due to the distribution length of this flexible circuit 35 becomes high, and as described above, leads to the noise of the semiconductor laser 2. To remove the noise of the semiconductor laser 2, there arises a need to increase the output of the high frequency superimposition element 36, and this causes increase of unnecessary radiation (high frequency noise) and increase of the operating current, and thus, there has been created a problem of deterioration of the performance of the disc recording and reproducing apparatus as well as the lowering of the battery life.

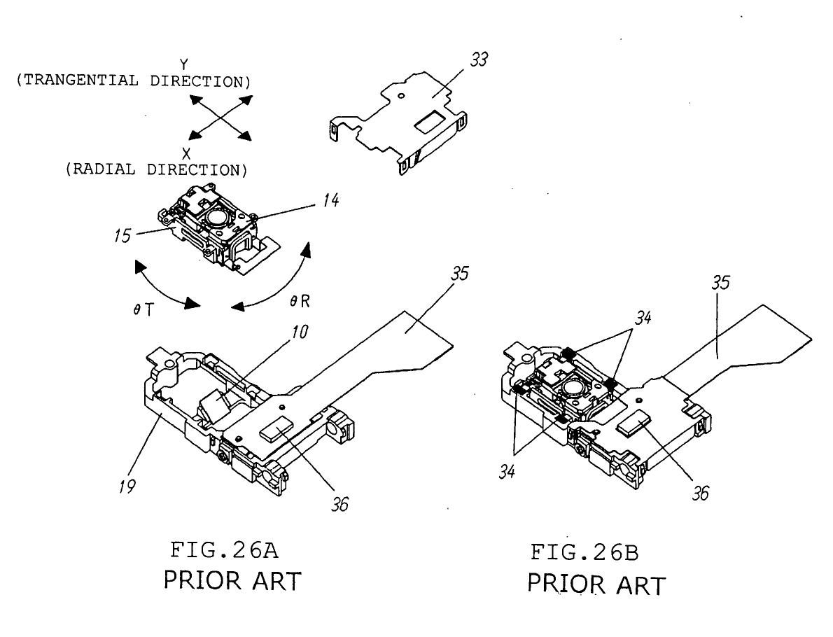

In contrast to this, according to the present embodiment, the wiring length between the semiconductor laser 2 and the high frequency superimposition generating circuit 56 substantially becomes a thickness of the multilayer ceramic substrate 50, and there is no need to pull out the wiring of the flexible circuit 35 as shown in FIG. 26A, and therefore, the distance with the semiconductor laser 2 can be made considerably short, and it is possible to reduce the impedance (more in particular, an inductance component which becomes a so-called L component) due to the distribution length, and the addition of an efficient high frequency superimposition to the semiconductor laser 2 can be realized, and it is possible to sharply reduce the output of the high frequency superimposition, and high frequency superimposition function excellent in performance can be realized.

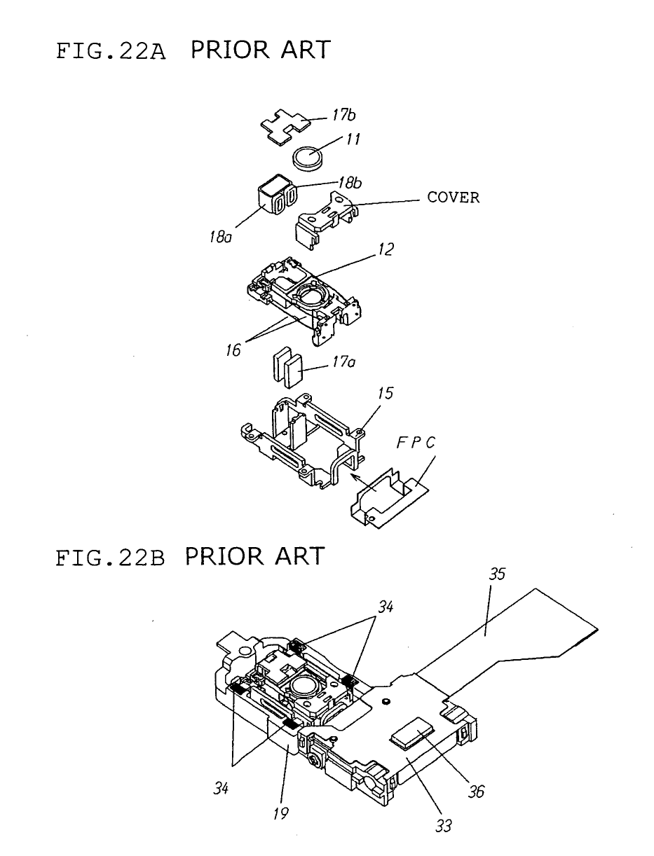

Further, in the present embodiment that, the light receiving and emitting element module 62 has an electrical wiring in the inside thereof, and comprises the pad 55b to connect with the flexible circuit 35 on its main surface, and therefore, there is no need to provide the terminal 5 and the metal frame 400 which surround the outer edge of the silicon substrate 1 and surround the periphery of the multisegment photodetector 3, and at the same time, are connected to the flexible circuit 35 similarly to the conventional example shown in FIG. 22. Consequently, it is possible to prevent the increase in the number of manufacturing processes of the integrated unit 9 including the preparing processes of the metal frame 400 and the like, and also cost-overrun.

Further, in the conventional example, since the high frequency superimposing element 36 is provided outside of the integrated unit 9 through the flexible circuit 35, the optical head becomes oversized, but in the present embodiment, since the high frequency superimposition generating circuit 36 is provided on the main surface of the multilayer ceramic substrate 50 where the multisegment photodetector 3 is not provided, this can further contribute to make the optical head miniaturized.

Although the terminal 5 and the metal frame 400, together with the resin package 6, are the cause of increase in the size of the fringe of the multi segment photodetector 3, particularly, in a width direction (W direction) and in a height direction (H direction), in the present embodiment, miniaturization by approximately ⅓ comparing to the conventional ratio in the W direction and by approximately 1(3+α) in the H direction can be realized. Here, α is a height portion of the high frequency superimposition generating circuit 56 mounted on the flexible circuit 35 in the conventional example.

The operation as the optical head of the present embodiment is performed similarly to the conventional example. That is, the light emitted from the semiconductor laser 2 is reflected by the folded mirror 151 so as to be changed approximately 90 degrees in its optical path, and is separated in to plural different light fluxes by a hologram element 7. The different plural light fluxes transmit the beam splitter 8a of the compound element 8, and are reflected by the reflecting mirror 10, and are collected on the magneto-optical recording medium 13 by the optical lens 11 fixed to the optical lens holder 12 as an optical spot 32 of approximately one micron in diameter.

Further, the light flux reflected by the beam splitter 8a of the compound element 8 enters the light receiving element 63 for the laser monitor, and controls the driving current of the semiconductor laser 2 by a laser power control circuit (not shown) based on the detected light quantity.

The reflected light from the magneto-optical recording medium 13 traces a reverse route, and is reflected and separated by the beam splitter 8a of the compound element 8, and enters the folded mirror 8b and the polarized light separation element 8c.

The semiconductor laser 2 is disposed so as to be directed to a polarized direction parallel with the sheet surface in FIG. 2A, and the incident light is rotated 45 degrees in its polarized direction by the polarized light separation element 8c, and at the same time, is separated into two light fluxes of mutually orthogonal polarized components, and enters the information signal light receiving area 27.

Further, from among the reflected lights from the magneto-optical recording medium 13, the light flux having transmitted the beam splitter 8a is separated into plural light fluxes by the diffraction grating 7, and is collected into the focus error signal light receiving area 24 and the tracking error signal light receiving areas 25 and 26.

A focus servo is performed by a SSD method, and a tracking servo is performed by a so-called push-pull method.

Further, by calculating the different between a main beam 22 comprising a P polarized light and a main beam 23 comprising a S polarized light, the detection of magneto-optical disc information signal by differential detection method is made possible. Further, by working out the sum thereof, it is possible to detect a pre-pit signal.

The multilayer ceramic substrate 50 of the light receiving and emitting element module 62 is fixed to the optical bed plate 19 by adhesive bond and the like. As a result, the dimension of the mounting portion of the multilayer ceramic substrate 50 in the optical bed plate 19 is prescribed in such a manner that for the position of the multisegment photodetector 3 in a Z′ axial direction, the light receiving face (optical axial direction), is located approximately at the midpoint of the focus points 30 and 31 of the optical spots of FIG. 2a).

Further, in the present embodiment, the relative positional adjustment among the semiconductor laser 2 to obtain a desired detection signal by the reflected light from the magneto-optical recording medium 13, the optical lens 11, and the multisegment optical detector 3 is performed as follows. A positioning hole 45 of the base 15 is retained by a chucking pin (not shown) of the external jig, and inside a flat surface approximately orthogonal to the optical axis incident on the optical lens, the optical lens driving device 14 is moved in a X direction (radial direction) and in a Y direction (tangential direction), thereby adjusting the outputs of the tracking error signal light receiving areas 25 and 26 so as to be approximately uniform. After the adjustment, with the state kept as it is, the base 15 is adhered and fixed to the optical bed plate 19 by using the adhesive agent 34. In this manner, the adjustment of the focus error signal and the tracking error signal is completed.

At this time, it goes without saying that, with the base 15 kept adhered and fixed to the optical bed plate 19 in advance, the object lens driving device 14 is adjusted in the X direction and Y direction for the base 15, and after that, even if the object lens driving device 14 is fixed to the base 15, the same effect can be obtained.

Further, the object lens 11 and the object lens driving device 14 (including the base 15) are fixed to the prescribed position of the optical bed plate 19 in advance, and after that, the light receiving and emitting element module 62 is adjusted in W and H directions, and then, the optical bed plate 19 and the multilayer ceramic substrate 50 are adhered, and even in that case, it goes without saying that the same effect can be obtained.

When the above described adjustment of the object lens driving device is performed inside the flat surface approximately orthogonal to the optical axis incident on the object lens 11, in order to perform the adjustment of the relative angle between the magneto-optical recording medium 13 and the object lens 11 at the same time, a skew adjustment of the object lens driving device 14 can be performed. That is, by using the same jig as described above, the external jig is rotated, so that the object lens driving device 14 is rotated and adjusted in a radial direction OR and a tangential direction OT, respectively.

As described above, according to the first embodiment of the present invention, the invention is characterized that in place of the conventional integrated unit 9, the light receiving and emitting element module 62 integrating the semiconductor laser 2, the multisegment photodetector 3, the high frequency superimposition generating circuit 56, and the folded mirror 151 is mounted on the multilayer ceramic substrate 50 with the wiring given to the ceramic.

By this configuration, it is possible to connect a wiring distance between the semiconductor laser 2 and the high frequency superimposition generating circuit 56 shortly and efficiently, and therefore, the resistance (impedance) can be made small, and the output of the high frequency superimposition generating circuit 56 can be sharply reduced, and unnecessary radiation can be reduced.

Further, there is no need of the resin package and the metal frame to secure strength, nor is there any need to provide the high frequency superimposition generating circuit 56 outside of the optical head, and therefore, heat dissipation efficiency, miniaturization, and thin-shape of the optical head can be realized.

Further, the multilayer ceramic substrate 50 is composed of heat conductive material such as ceramic or glass epoxy and the like excellent in heat transferability comparing with resin, and further, because of the configuration having the heat transfer pad 52 and the heat dissipation pad 53 as well as the via hole 54 in the inside thereof excellent in heat dissipation property, it is possible to effectively transfer and dissipate the heat generation from the semiconductor laser 2, and therefore, the temperature rise of the semiconductor laser 2 which becomes the light source can be prevented, and the deterioration of the life of the semiconductor laser 2 can be prevented.

At this time, though the multilayer ceramic substrate 50 takes ceramic as its material, it may be composed of the material such as a single layer or multilayer (in each layer and inside the layer, there is provided a conductive material comprising metal such as a copper foil or gold and the like similarly to the multilayer ceramic substrate 50 as a signal wiring or a heat dissipation circuit) glass epoxy and the like.

Further, though the via holes 54 are all taken as serving both as the circuit wiring and the heat transfer route, some via holes are not used for electrical connection, but are simply used as heat transfer thermal via holes. At this time, in place of metal such as gold, copper and the like, the via hole may be formed by using conducting paste.

Further, the multilayer ceramic substrate 50 has a constitution in which it retains the semiconductor laser 2 and the silicon substrate 1 in a heat transfer state through the solder 57 and a silver paste 58, and has a heat transfer route to transfer the heat of the surface mounted with the semiconductor laser 2 and the silicon substrate 1 to an opposite surface or a side surface, and transfers and dissipates the transferred heat to the heat dissipation pad 53 or the optical bed plate 19 and the flexible circuit 35 which become other constituent parts. By this configuration, it is possible to effectively transfer the heat generated from the semiconductor laser 2 which becomes the light source to other places, so that the heat dissipation property can be increasingly improved, and the optical head excellent in reliability can be realized.

The present embodiment has a static electricity protection mechanism in which the LD terminal and the LD-GND terminal which become two electrodes of the semiconductor laser 2 are wired on the multilayer ceramic substrate 50 directly or through the silicon substrate 1, and the two terminals (LD terminal 2a and LD-GND terminal 2b) composed on the multilayer ceramic 50 can be put into an electrically conductive state by solder, wiring or conductive components, and at the same time, the space between the two electrodes can be put into a non-conductive state by cutting off the wiring and removing the solder or the conductive components on the multilayer ceramic substrate.

By this configuration, the semiconductor laser 2 can be protected from the static electricity, and therefore, it is possible to realize the disc recording and reproducing apparatus excellent in reliability, and at the same time, it is possible to protect the semiconductor laser 2 from the static electricity even when it is left unattended or transported in the state of the light receiving and emitting element module 62, and therefore, it is possible to realize the light receiving and emitting element module 62 excellent in handling property.

In the first embodiment, though the high frequency superimposition generating circuit 56 is an example of the high frequency superimposition adding device of the present invention, and is represented by a condenser, an oscillator and the like, if the function of the high frequency superimposition generating circuit 56 is satisfied, naturally it does not matter whatever electronic component is used.

Further, the improvement of the recording and reproducing performance, the sharp improvement of the battery life, and the light receiving and emitting element as well as the disc recording and reproducing apparatus excellent in the heat dissipation property can be realized, and at the same time, the light receiving and emitting elements (the semiconductor laser 2 and the multisegment photodetector 3) and the high frequency superimposition generating circuit 56 are integrated and modularized on the multilayer ceramic substrate 50 in such a manner as to be sharply miniaturized, so that a miniaturized and thinly shaped optical head and the disc recording and reproducing apparatus can be realized.

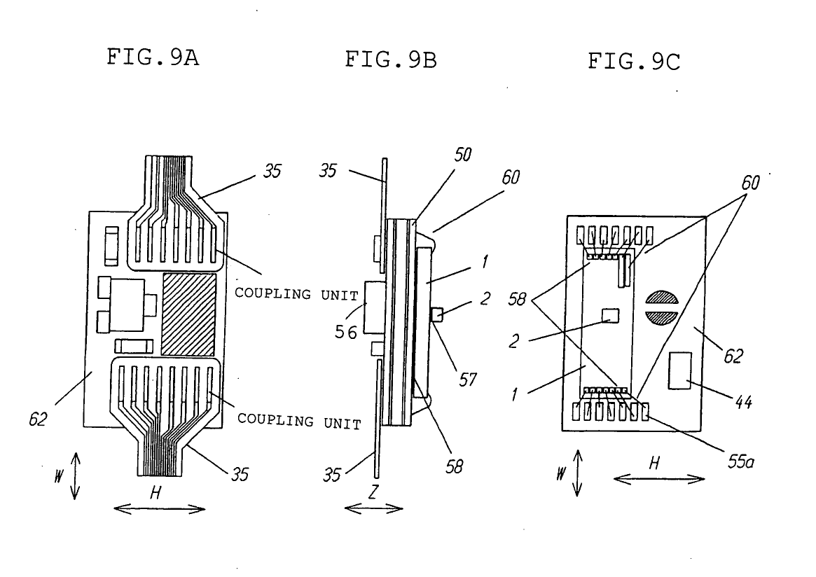

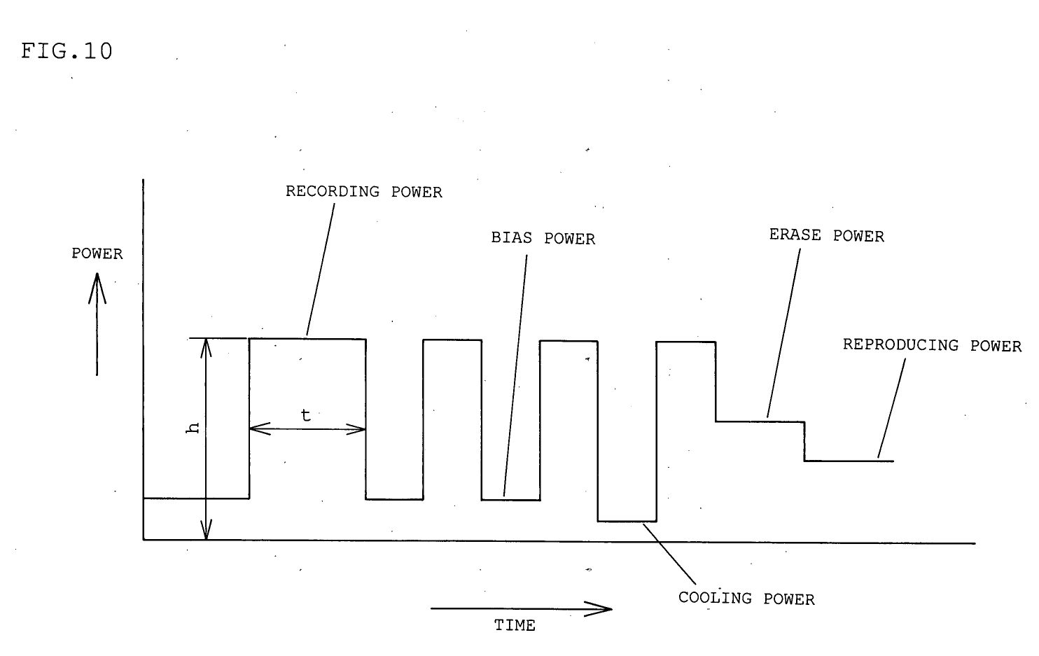

Further, according to the above described description, in order to reduce the generation of the laser noise by the interference between the light emitted from the semiconductor laser 2 and the returned light from the magneto-optical recording medium 13, modulation of several hundreds MHz has been added to the driving current of the semiconductor laser 2 from the high frequency superimposition circuit 56. However, as shown in FIGS. 9C and 10, a semiconductor laser driving circuit 44 to generate a so-called light pulse (strategy) which changes a recording power of the semiconductor laser 2 at the recording time may be additionally mounted. At this time, the high frequency superimposition generating circuit 56 may be actuated at the reproducing time, and the semiconductor laser driving circuit 44 may be actuated at the recording time. Alternatively, according to the type of the information recording medium, a method of arbitrarily selecting either of the circuits may be adopted or both the high frequency recording superimposition generating circuit 56 and the semiconductor laser driving circuit 44 may be actuated. The semiconductor laser driving circuit 44 is an example of the modulation signal adding device and the laser driving device of the present invention.

A light pulse shown in FIG. 10 is a so-called light strategy, and the values of a recording power, a bias power, an erasing power, a reproducing power, a time t of cooling power, and a power h can be arbitrarily set (this setting may be performed soft-wise or hard-wise).

By mounting the semiconductor laser driving circuit 44 on the multilayer ceramic substrate 50, similarly to the case of the high frequency superimposing generating circuit 56, the distance with the semiconductor laser 2 can be made short, and it is possible to make a stray capacitance small, which becomes a C component between the inductance which becomes a so-called L component and each line. It is possible to reduce the rounding of the waveform of the light strategy, and is possible to apply a light pulse close to an ideal state to the semiconductor laser 2, and the optical head and the disc recording and reproducing apparatus excellent in recording and reproducing performance can be realized. Though a description has been made that the semiconductor laser driving circuit 44 is provided on the same surface where the high frequency superimposition generating circuit 56 is provided, the circuit 44 may be provided on the side where the silicon substrate 1 is provided.

In the first embodiment, though the light receiving and emitting element module 62 is mounted with the semiconductor laser 2 which becomes the light source and the multisegment photodetector 3 which becomes the light receiving element, there is no problem in that the multisegment photodetector 3 which becomes the light receiving element is not mounted, but the semiconductor laser 2 and the modulating device of the current or the power of the light source only are directly composed on the multilayer ceramic substrate 50.

Further, though a description has been made that the multisegment photodetector 3, as shown in FIG. 4, is collectively formed with the focus error signal light receiving area 24, the tracking error signal light receiving areas 25 and 26 on the silicon substrate 1, all or part of receiving areas may be disposed outside of the light receiving and emitting element module 62. For example, as shown in FIG. 2C, By alternating the grating of hologram element 7, focal points 30 and 31 for detecting focus error signal are shifted from the surface of silicon substrate 1. In this case, focus error signal light receiving area 24 with which focal points 30 and 31 are coincided are provided in the optical base 19 where the light receiving and emitting element module is mounted.

Further, it goes without saying that each light receiving surface of the multisegment photodetector 3 may have either a system of converting the incident light into the current or a so-called OEIC configuration in which a built-in amplifier is mounted and the current is converted further into the voltage, thereby raising a gain. At this time, the built-in amplifier corresponds to the amplifier of the present invention.

Further, in the first embodiment, though the high frequency superimposition generating circuit 56 or the semiconductor laser driving circuit 44 are mounted on the multilayer ceramic substrate 50, either the high frequency superimposition generating circuit 56 or the semiconductor laser driving circuit 44 may be mounted or neither of the circuits may be mounted.

Further, in the first embodiment, either the semiconductor laser 2 or the multisegment photodetector 3 may be mounted on the multilayer ceramic substrate 50.

Further, in the first embodiment, though surface mount components such as the multisegment optical detector 3 and the high frequency superimposition generating circuit 56 mounted through the pads 55a and 55b provided on both sides of the multilayer ceramic substrate 50 have been connected, the electrodes of the present invention, shown as the pad 55c in FIG. 7B, may be provided on the side surface of the multilayer ceramic substrate 50. This is effective in a case where there is no space available to provide the pad 55a and the like under both arms of the multisegment photodetector 3 and the high frequency superimposition generating circuit 56.

In this case, the physical disposition and the thermal connection of the multisegment photodetector 3 and the high frequency superimposition generating circuit 56 are performed on the multilayer ceramic substrate 50, and the electrical connection to the flexible circuit 35 is performed by wire bonding and the like through the side surface electrodes of the multilayer ceramic substrate 50 and the signal wiring inside the layer.

Further, in the first embodiment, though a description has been made that the surface mount components such as the multisegment photodetector 3 and the high frequency superimposition generating circuit 56 are mounted through the pad 55a and 55b provided on both surfaces of the multilayer ceramic substrate 50, and as shown in FIG. 6B, the peripheries of the pad 55a and the wire boding 60 are exposed to the outside air, to prevent oxidation and the like of the pad 55a and the wire bonding 60, the connected portions may be sealed by sealant comprising resin, silicon rubber or the adhesive agent. Further, to allow the sealant to be effectively retained in the periphery of the pad 55a, the surface of the multilayer ceramic substrate 50 may be provided with a step at the portion where the pad 55a is disposed. In this manner, the pad 55a is disposed insider the step, and can be easily sealed by the sealant after being connected by the wire bonding 60.

Further, in the first embodiment, in the light receiving and emitting element module 62, a description has been made that the surface mount components such as the multisegment photodetector 3 and the high frequency superimposition generating circuit 56, as shown in FIGS. 6A and 6B, are disposed on both surfaces of the multilayer ceramic substrate 50, and the light receiving and emitting element module 62, as shown in FIG. 1A, is mounted inside the optical bed plate 19. However, on the purpose of positioning of the disposition, temporal tacking with the optical bed plate 19, and steady retention of each surface mount components, the surface and the side surface of the multilayer ceramic substrate 50 may be formed with unevenness at desired places by notching, etching, and the like.

### Second Embodiment

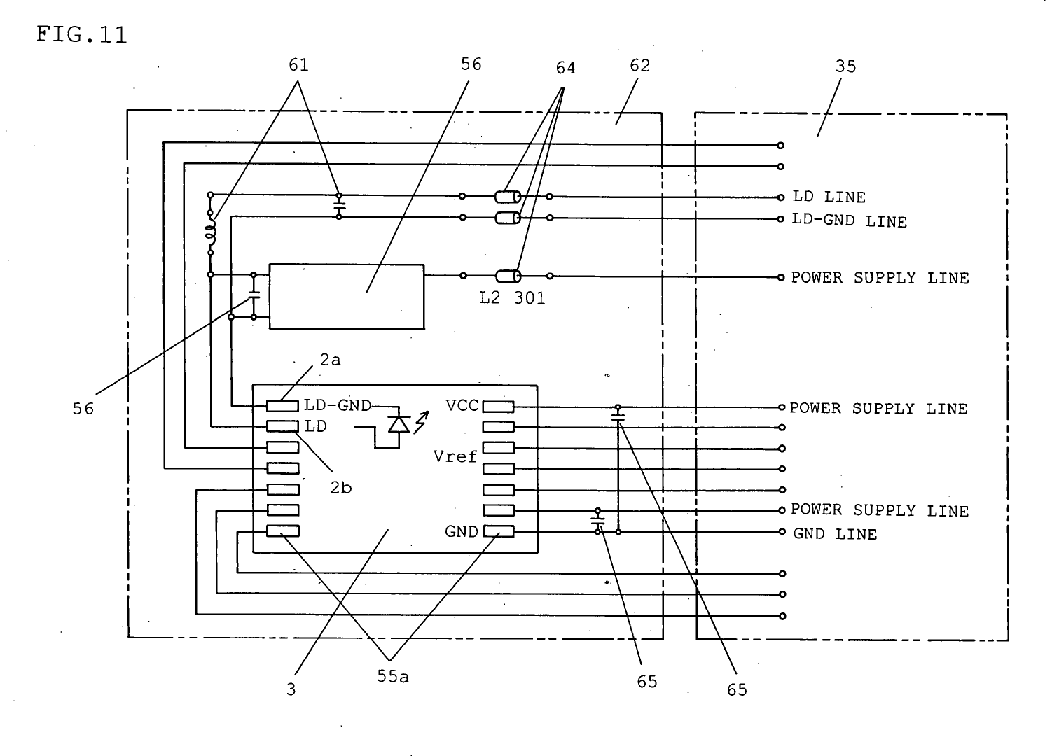

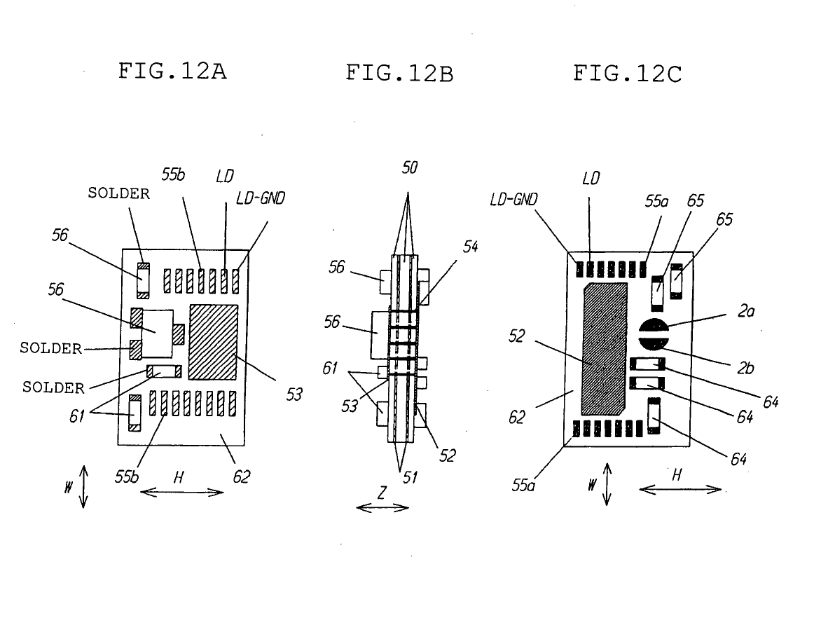

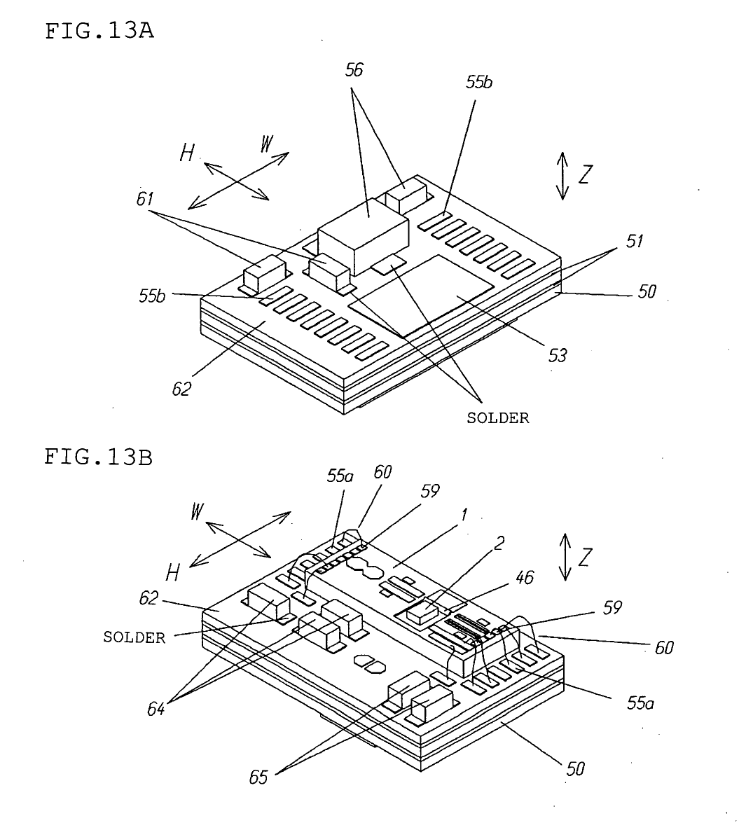

Next, a second embodiment will be described with reference to FIGS. 11, 12, and 13. However, FIG. 11 is a circuit diagram showing a wiring state between a light receiving and emitting element module 62 and a flexible circuit 35, FIGS. 12A to 12C are three views showing a mounting state of each component in the light receiving and emitting element module 62, and FIGS. 13A and 13B are oblique views showing a mounting state of each component in the light receiving and emitting element module 62.

The present embodiment is different from the first embodiment in that the light receiving and emitting element module 62 is additionally mounted with an anti-static electricity filter 61, a high frequency filter 64, and a noise reduction condenser 65 on a multilayer ceramic substrate 50.

The surface of the multilayer ceramic substrate 50 is mounted with the anti-static electricity filter 61 comprising electronic parts such as a condenser or a coil (resister) or a filter, thereby constructing a static electricity alleviation mechanism to alleviate a sharp potential difference generated in a LD 2a and a LD-GND 2b, which become two electrodes of the semiconductor laser 2 by the effect of the static electricity, and it is possible to reduce the effect of the static electricity even in case the two electrodes of the semiconductor laser 2 are electrically non-conductive, and a light receiving and emitting element module which is a miniaturized light receiving and emitting element and an optical head improved more in reliability for the static electricity can be realized.

The high frequency filter 64 is a so-called band pass filter (bead) to shut off a specific high frequency component only, and reduces a leakage of high frequency from a high frequency superimposition generating circuit 56 which leaks into a LD line and a LD-GND line of the semiconductor laser 2 and the power supply line of the high frequency superimposition generating circuit 56, and it is possible to sharply reduce unnecessary radiation of several hundreds MHz to several GHz by adjusting the characteristic of the band pass filter.

Further, a condenser 65 is mounted on the power supply line of a multisegment optical detector 3, and can sharply reduce the noise leaked into the power supply of the multisegment optical detector 3. By mounting a high frequency filter 64 and the noise reduction condenser 65, high performance optical head and disc recording and reproducing apparatus having few noise and unnecessary radiation can be realized.

In the first and second embodiments, the multilayer ceramic substrate 50 is provided with electronic parts having functions such as a condenser, a resister or a filter and the like on the surface. By this configuration, more higher integration is made possible, and a miniaturized optical head and a miniaturized disc recording and reproducing apparatus can be realized.

In the above described configuration, the anti-static filter 61 is equivalent to a first passive element of the present invention, the high frequency filter 64 is equivalent to a second passive element of the present invention, and the condenser 65 is equivalent to a third passive element of the present invention.

Further, the mounting positions of the anti-static electricity filer 61, the high frequency filter 64, and the condenser 65 are not limited to the examples shown in FIGS. 12A to 12C and FIG. 13c. As far as the connections shown in FIG. 11 are satisfied, the mounting positions may be provided on any place of both surfaces of the multilayer ceramic substrate 50. Further, all of the anti-static electricity filter 61, the high frequency filter 64, and the condenser 65 may not be mounted. At least one of them may be provided.

### Third Embodiment

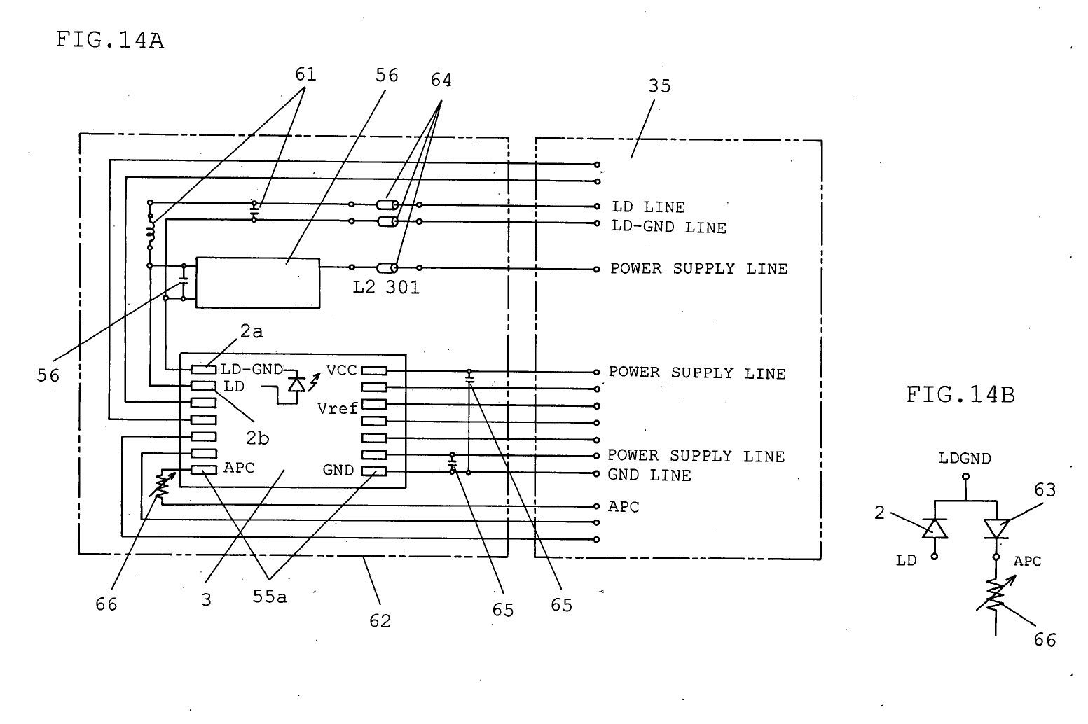

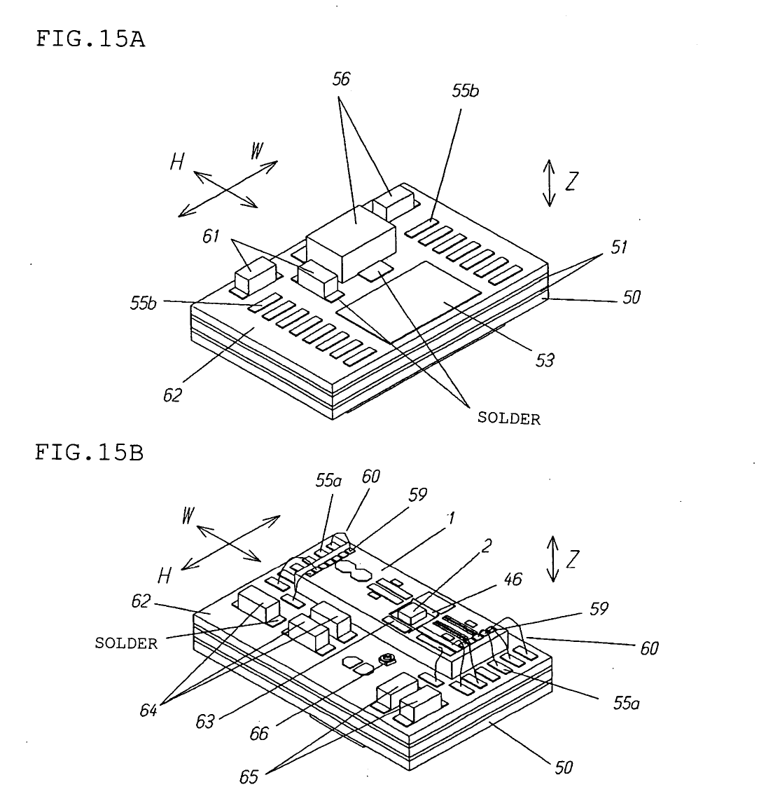

Next, a third embodiment will be described with reference to FIGS. 14 and 15. However, FIGS. 14A and 14B is a circuit diagram showing a wiring state between a light receiving and emitting element module 62 and a flexible circuit 35, and FIGS. 15A and 15B are oblique views showing a mounting state of each component in the light receiving and emitting element module 62.

The present embodiment is difference from the first embodiment in that a light receiving element 63 for a laser monitor and a gain adjustment mechanism 66 are additionally mounted on the light receiving and emitting element module 62. The light receiving element 63 for the laser monitor is mounted on a silicon substrate 1 as a portion of a multisegment photodetector 3, and is means of detecting a light quantity emitted from the end surface opposing to the light emitting surface of a semiconductor laser 2. Further, the gain adjustment mechanism 66 is directly mounted on a multilayer ceramic substrate 50, and adjusts the gain of the current or the voltage by the operation from the outside. By this configuration, an optical head can be increasingly miniaturized, and a disc recording and reproducing apparatus can be increasingly miniaturized and thin-shaped.

In the third embodiment, though both the light receiving element 63 for the laser monitor and the gain adjustment mechanism 66 (adjustment volume and the like) are mounted on the light receiving and emitting element module 62, either one of them may be mounted according to the size of the light receiving and emitting element module 62. Further, the gain adjustment mechanism 66 may be mounted on a silicon substrate 1 as a portion of the multisegment photodetector 3.

The light receiving element 63 for the laser monitor is equivalent to the light emitting quantity detection means of the present invention, and the gain adjustment mechanism 66 is equivalent to the adjusting means of the present invention.

### Fourth Embodiment

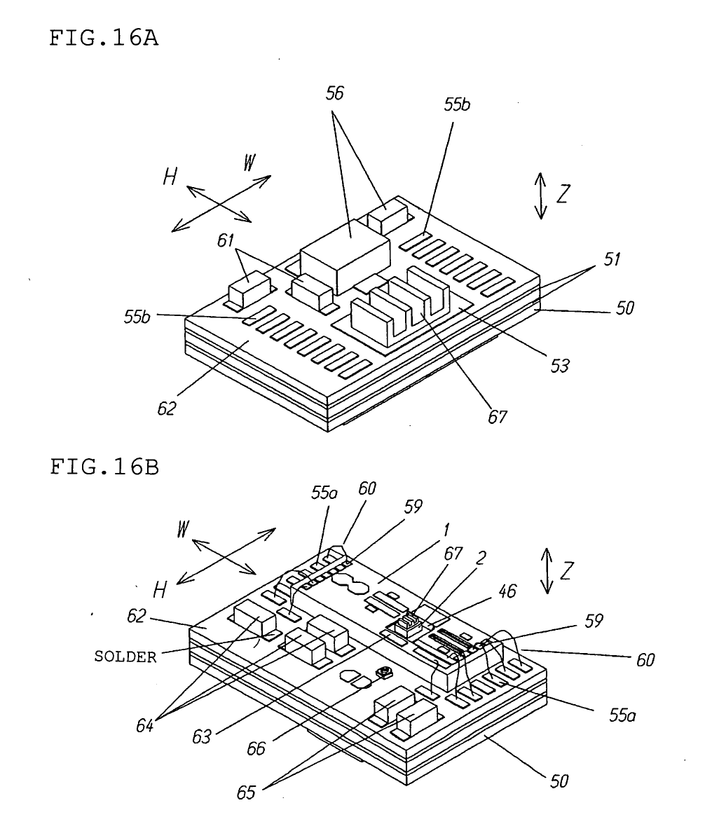

Next, a fourth embodiment will be described with reference to FIG. 16. However, FIGS. 16A and 16B are oblique views showing a mounting state of each component in a light receiving and emitting element module 62.

The present embodiment is different from the first embodiment in that, as shown in FIG. 16A, the present embodiment further comprises a heat dissipation fin 67 made of metal or ceramic for heat dissipation and securing a constant heat capacity by a silver paste, a solder or a heat transfer adhesive agent, ultrasonic welding or welding and the like on the surface (surface of a heat dissipation pad 53 or a multilayer ceramic substrate 50) opposing to the surface where a semiconductor laser 2 of the multilayer ceramic substrate 50 and a silicon substrate 1 are mounted. By this configuration, a light receiving and emitting element module and an optical head more excellent in heat dissipation property can be realized.

In the constitutional example shown in FIG. 16A, though the heat dissipation fin 67 is mounted on the main surface of the multilayer ceramic substrate 50, as shown in FIG. 16B, the fin may be mounted on any surface of a semiconductor laser 2. Further, the fin may be mounted at any position on the silicon substrate 1. Further, though the heat dissipation fin 67 is an example of a second heat radiator of the present invention, it is not limited to its specific shape, and in place of its specific shape, the fin 67 may be a metal plate member like a heat dissipation plate. Further, the fin 67 is not limited to the disposition, and a system of mounting the heat dissipation fin or the heat dissipation plate at the side surface of the multilayer ceramic substrate 50 may be adopted.

### Fifth Embodiment

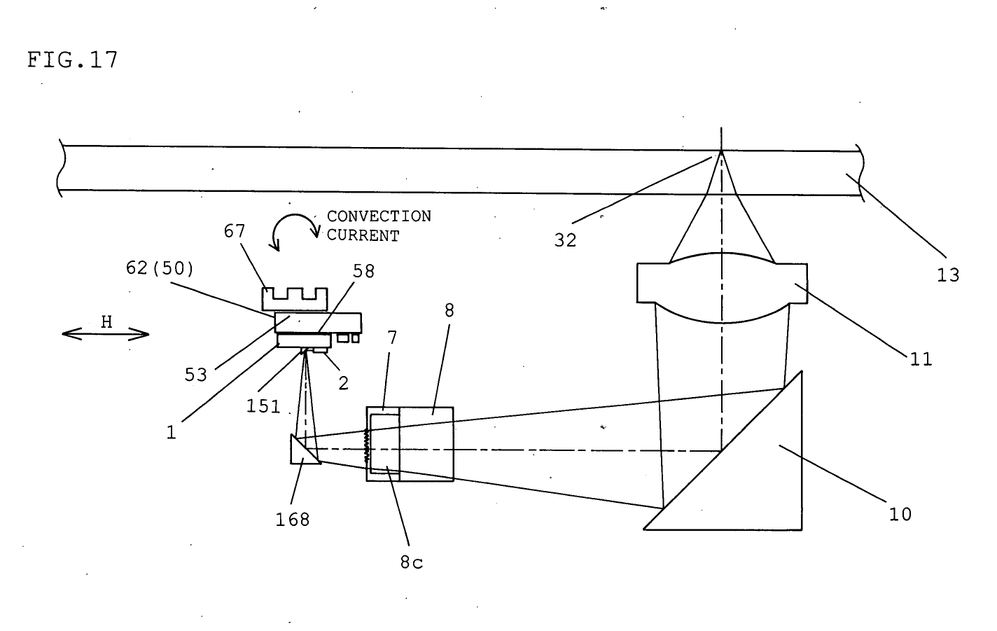

Next, a fifth embodiment will be described with reference to FIG. 17. However, FIGS. 16A and 16B are views showing an optical head mounted with a light receiving and emitting element module 62 and the optical disposition of its vicinity.

The present embodiment is different from the first embodiment shown in FIG. 2B in that a reflecting mirror 168 is provided in the optical path between the light receiving and emitting element module 62 and a hologram element 7, so that the optical path of the light flux reflected by a folded mirror 151 is further bent 90 degrees by a reflecting mirror 168, and a heat dissipation pad 53 and a heat dissipation fin 67 of the light receiving and emitting element module 62 are disposed on the surface opposing to a magneto-optical recording medium 13. By this configuration, the heat dissipation fin 67 is exposed to a convection current generated by the rotation of the magneto-optical recording medium 13, thereby improving the heat dissipation property and the reliability of a semiconductor laser 2.

In the fifth embodiment, though the heat dissipation fin 67 is provided on the heat dissipation pad 53 or the multilayer ceramic substrate 50, with no heat dissipation fin 67 available, by the heat dissipation pad 53 and the multilayer ceramic substrate 50, the heat may be dissipated by the convection current from the magneto-optical recording medium 13. To sum up, the light receiving and emitting element module 62 within the optical head may be disposed in such a manner that the rear surface of the substrate (opposite to the side where the laser beam emits) and the information recording surface of the optical disc are substantially opposed.

### Sixth Embodiment

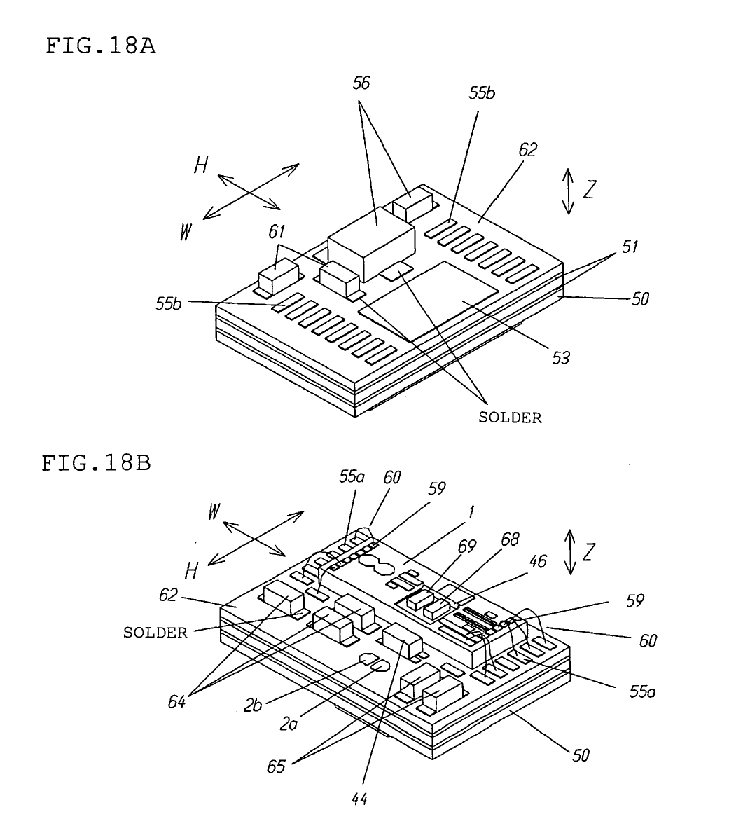

Next, a sixth embodiment will be described with reference to FIG. 18. However, FIGS. 18A and 18B are oblique views showing a mounting state of each part in a light receiving and emitting element module 62.

The present embodiment is different from the first embodiment in that plural semiconductor lasers are provided in a multisegment photodetector 3 formed on a multilayer ceramic substrate 50. In FIG. 18B, reference numeral 68 denotes a semiconductor laser a (central wavelength from approximately 700 nm to 800 nm), reference numeral 69 a semiconductor laser of the double wavelength of a semiconductor laser b (central wavelength from 600 nm to 700 nm), which can switch over a light source according to the type of information recording medium based on a control signal from the outside. By this configuration, even for a plurality of information recording media such as CD and DVD which are different in the wavelength of a laser light used in recording and reproducing, the recording or reproducing can be performed by one optical head, and therefore, a miniaturized, thin-shaped, and low-cost disc recording and reproducing apparatus can be realized.

In the sixth embodiment, though light sources mounted on the surface of the multilayer ceramic substrate 50 are taken as the semiconductor laser a and the semiconductor laser b, the light sources of different wavelengths (for example, 350 nm to 450 nm) may be further mounted, and three or more light sources may be mounted. Even if the lasers are of the same wavelength, the high output laser (for recording) and the low output laser (for reproducing) may be mounted. Further, the wavelength of the light source which is emitted from the semiconductor laser a 68 is not one only, and the semiconductor laser of a so-called hybrid type which is emitted by different plural wavelengths may be mounted.

Further, according to the type of the light source or a state of recording and reproducing as well as the type of information recording medium, if the light source, a high frequency superimposition generating circuit 56, and a semiconductor laser driving circuit 44 are arbitrarily combined (switched over by programming by a specific IC soft-wise and hard-wise), it is possible to make the optical head and the disc recording and reproduction apparatus ever-increasingly miniaturized and thin-shaped.

### Seventh Embodiment

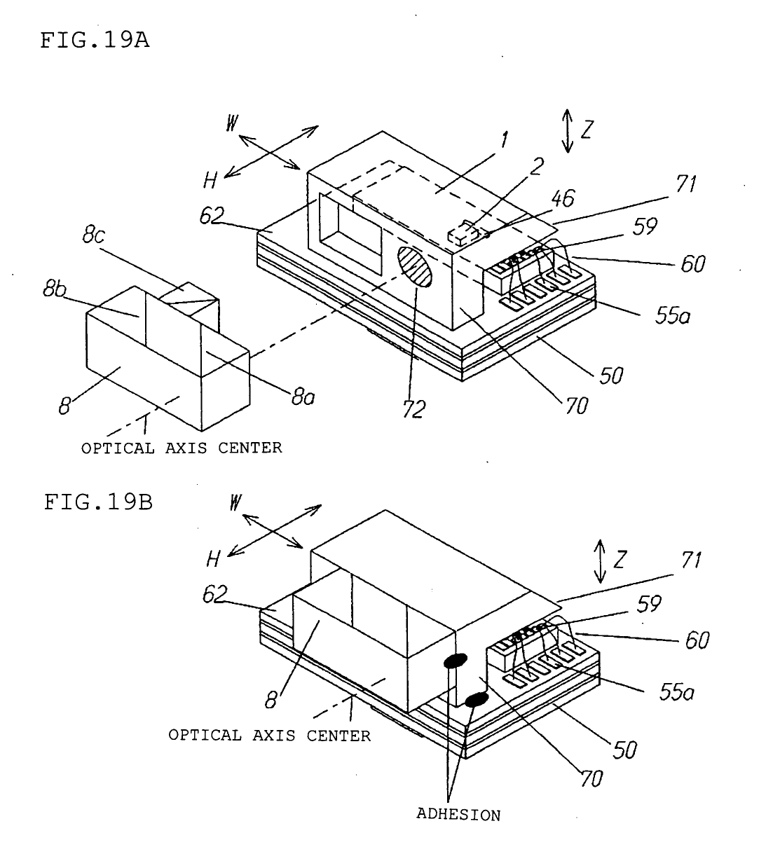

Next, a seventh embodiment will be described with reference to FIG. 19. However, FIGS. 19A and 19B are oblique views to explain a mounting state of each part in a light receiving and emitting element module 62.

The present embodiment is different from the first embodiment in that an optical element 70 is precisely integrated on the light receiving and emitting element module 62.

The optical element 70 is composed of resin, glass or transparent ceramic, and has a reflecting mirror 71 and a hologram 72. Further, a compound element 8 (beam splitter 8a, folded mirror 8b, and a polarized light separation element 8c) is also adhered and fixed. Further, the optical element 70 is precisely adhered and fixed to a multilayer ceramic substrate 50. By integrating the optical element 70 and the light receiving and emitting module 62, it is possible to make the optical head increasingly miniaturized and thin-shaped, thereby realizing a miniaturized disc recording and reproducing apparatus.

In the seventh embodiment, though the reflecting mirror 71 is deposited with a metal film of aluminum or gold and the like or a dielectric multilayer film on the optical element 70, a reflecting mirror of other members composed of glass or resin and the like may be adhered on the optical element 70 by adhesion and the like.

Further, in the seventh embodiment, though the optical element 70 is fitted with the hologram 72, and is adhered with the compound element 8, whatever parts may be mounted if they are optical functional parts such as a lens, a wave plate, a light shielding layer, and the like. Here, the optical element 70, the compound element 8, and other optical functional parts are equivalent to the optical elements of the present invention.

Further, a multilayer ceramic substrate 50 is provided with a hole to mount an optical lens 11, and the optical lens 11 may be adhered and fixed on the multilayer ceramic substrate 50.

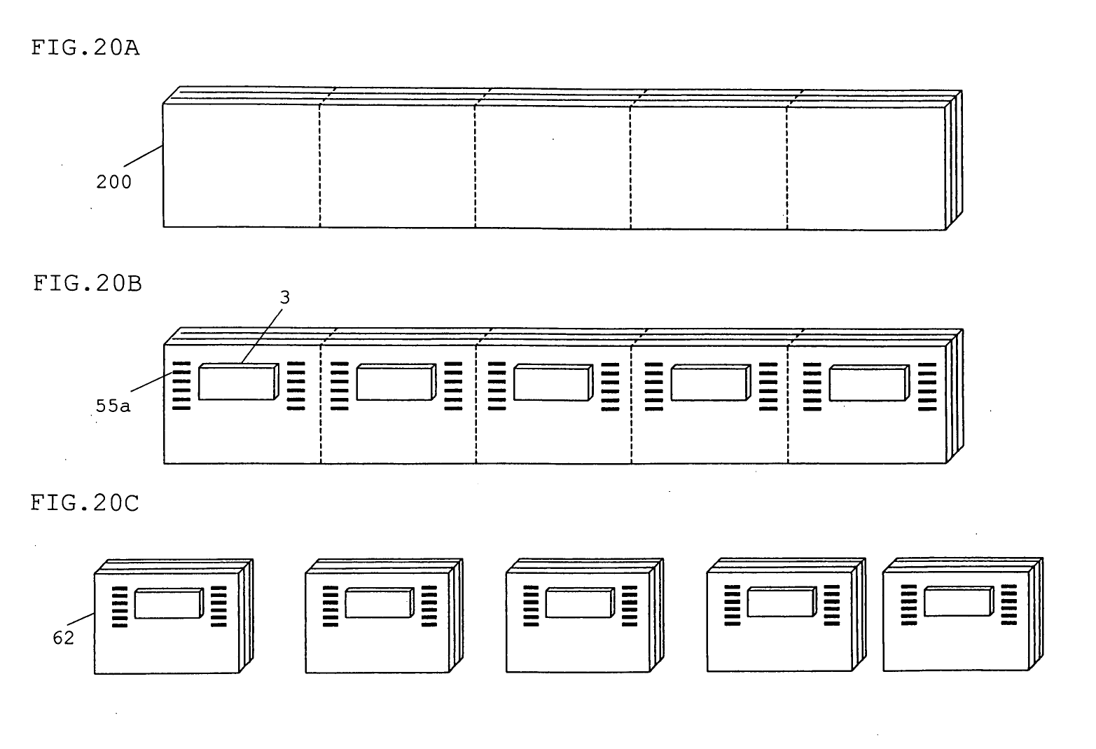

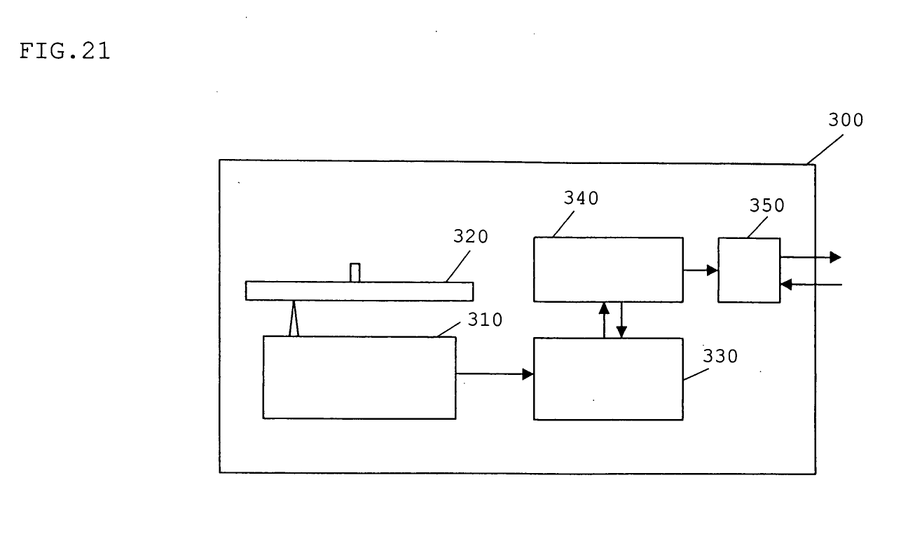

As the manufacturing method of the light receiving and emitting element module 62, as shown in FIG. 20A, a multilayer ceramic body 200 composed by periodically providing internal wirings of the same pattern in each layer and between layers or on the surface in advance is prepared, and as shown in FIG. 21B, the surface mount components of a multisegment optical detector 3 and the like and electrodes of a pad 55a and the like are provided so as to correspond to each periodical pattern, and the wiring of each component is performed by a wire bonding, a bump and the like. At this time, the electrical connecting components such the pad 55a and the like, as described in the first embodiment, may be given a process of sealing so as not to be exposed to the outside air.

Finally, as shown in FIG. 20C, the multilayer ceramic body 200 is divided for each periodical pattern, thereby individually obtaining the light receiving and emitting element module 62.

In the above explanation, though a description has been made that the multilayer ceramic body 200 is composed by providing the internal wiring of the periodical pattern along a line, since the number of pieces of the multilayer ceramic substrate 50 cut from a piece of the multilayer ceramic body 200 having a small area can be taken out in plenty, the periodic pattern may be formed along a lattice-like design.

Further, in each of the above described embodiments, though a description has been made revolving around the light receiving and emitting element module 62 and the optical head mounted with the module, the present invention, as shown in FIG. 21, may be provided with an optical head 310 mounted with the light receiving and emitting element module 62, and may be realized as a disc recording and reproducing apparatus 300 composed of recording/reproducing means 330 to record and reproduce information from an optical disc 320 as information recording medium by the optical head 310. The signal read from the recording/reproducing 330 is processed by information processing means 340, and is handled as utilizable information at the outside through an interface 350.

The present invention is utilizable as a light emitting module, an optical head, an optical disc recording and reproducing apparatus, and the like excellent in heat dissipation property, miniaturization, thin-shape, and high reliability.

What is claimed is:

1. A light emitting module used for an optical head having a light source and a single or plural light receiving elements and for using record or reproduce information on information recording medium, comprising:
a tabular conductive multilayer substrate; and
at least a surface mount component mounted on said conductive multilayer substrate;
said light emitting module includes at least said light source as said surface mount component.

2. The light emitting module according to claim 1, wherein said conductive multilayer substrates comprises a heat transfer route to transfer a heat at the side where said surface mount component is mounted to a portion other than said surface mount component.

3. The light emitting module according to claim 2, wherein said heat transfer route is a via hole made from a metal or a conductive paste.

4. The light emitting module according to claim 1, wherein said conductive multilayer substrate is composed by laminating a ceramic substrate and/or glass epoxy substrate.

5. The light emitting module according to claim 1, comprising at least one of said light emitting elements as said surface mount component.

6. The light emitting module according to claim 1, comprising a first heat radiator made from metal or ceramic which is provided on a surface opposing to the surface mounted with said surface mount component of said conducive multilayer substrate.

7. The light emitting module according to claim 1, comprising a modulation signal adding device to add a modulation signal to said light source as said surface mount component.

8. The light emitting module according to claim 7, wherein said modulation signal adding device is mounted on a surface opposing to the surface where said light source of said conductive multilayer substrate is mounted.

9. The light emitting module according to claim 7, wherein said modulation signal adding device includes a high frequency superimposition adding device to add a high frequency superimposition operation to said light source.

10. The light emitting module according to claim 7, wherein said modulation signal adding device includes a laser driving device to perform a multi-valued control of the light emitting power of said light source.

11. The light emitting module according to claim 1, comprising a static protection mechanism, which makes it possible to put a space between two electrodes of said light source as said surface mount component into an electrically conductive state by solder, wiring or conductive component on said conductive multilayer substrate, and at the same time, to put a space between said two electrodes on said conductive multilayer substrate into a non-conductive state by cutting said wiring and removing said solder or said conductive part.

12. The light emitting module according to claim 1, comprising a first passive element as said surface mount component having a static electricity alleviation function to alleviate a potential difference generated in two electrodes of said light source.

13. The light emitting module according to claim 5, comprising a second passive element as said surface mount component inserted into the power supply line or the signal line of said passive element, and having a noise removal function to remove a noise generated in said power supply line or the signal line.

14. The light emitting module according to claim 7, comprising a third passive element as said surface mount component having a filter function to shut off or let pass through the signal of a specific frequency band leaked from said modulation signal adding device.

15. The light emitting module according to claim 1, wherein said surface mount component has:
light emission quantity detection means to detect the light emission quantity of said light source; and
adjustment means to accept the adjustment of detection sensitivity of said light emission amount detection means on said conductive multilayer substrate.

16. The light emitting module according to claim 1, comprising a second heat radiator provided on the front surface or the side surface of said conductive multilayer substrate.

17. The light emitting module according to claim 16, wherein said second heat radiator is disposed at a position so as to be substantially opposed to the main surface of said information recording medium.

18. The light emitting module according to claim 1, wherein said light source is two or more light sources having different wavelengths.

19. The light emitting module according to claim 1, comprising a single or plural optical elements as said surface mount component to form a light path connecting said light source and/or said light receiving element and at least said object lens.

20. The light emitting module according to claim 1, wherein said surface mount component is fixed to said conductive multilayer substrate by silver paste or solder in a heat transfer and conductive state.

21. The light emitting module according to claim 1, wherein said conductive multilayer substrate and said surface mount component are wired by metal wire or bump.

22. The light emitting module according to claim 21, wherein said metal wire and connecting portions of said metal wire or connecting portions of said bump are sealed by sealant comprising resin, silicon rubber or adhesive agent.

23. The light emitting module according to claim 22, wherein a portion of said conductive multilayer substrate has a step, and said step is provided with said metal wire or said metal wire connecting portion, and the connecting portion of said bump is provided with stored sealant of said sealant.

24. The light emitting module according to claim 1, comprising an unevenness provided on the surface of said conductive multilayer substrate for positioning or retaining said surface mount component or said conductive multilayer substrate.

25. The light emitting module according to claim 1, comprising electrodes provided on the side surface of said conductive multilayer substrate.

26. An optical head, comprising:
a light source;
an object lens letting enter a light flux from said light source and collecting it on information recording medium;
an object lens driving device driving said object lens in a focus direction and a tracking direction of said information recording medium;
a single or plural light receiving elements receiving a light flux having reflected by said information recording medium and transmitted said object lens to generate the current based on said light quantity received, and
said optical head having at least said light source as the light emitting module according to claim 1.

27. The light emitting module according to claim 26, comprising a current voltage converter to convert the current generated by said light receiving element into voltage and an amplifier to amplify said current or said voltage.

28. The optical head according to claim 26, comprising an arithmetic circuit detecting the value of said current or voltage and generating a part of the servo signal or the servo signal of said object lens driving device.

29. The optical head according to claim 26, comprising an arithmetic circuit detecting the value of said current or voltage and reading the recording signal on said information recording medium.

30. A manufacturing method of the light emitting module according to claim 1, comprising the steps of:
wiring the surface mount components on the main surface of the conductive multilayer substrate having the wiring inside each layer, between layers or on the surface by metal wire or bump wire, and
dividing a predetermined portion of said conductive substrate body.

31. An optical disc recording and reproducing apparatus, comprising;
the optical head according to claim 26, and
information recording/reproducing means to perform the recording or reproducing of information from information recording medium by said optical head.
